(19) United States
(12) Patent Application Publication
(10) Pub. No.: US 2015/0116122 A1
(43) Pub. Date: Apr. 30, 2015

(54) TRAINING SYSTEM AND METHOD

(71) Applicant: Jerl Lamont Laws, Oakland, CA (US)

(72) Inventors: Jerl Lamont Laws, Oakland, CA (US); Ben Wilson, Vallejo, CA (US)

(21) Appl. No.: 14/523,204

(22) Filed: Oct. 24, 2014

Related U.S. Application Data
(60) Provisional application No. 61/895,296, filed on Oct. 24, 2013.

(51) Int. Cl. A63B 71/06; G08B 5/22

(52) U.S. Cl. CPC A63B 71/0619; G08B 5/22; A63B 2071/0658
USPC 340/815.4

(57) ABSTRACT

A method and system is presented that may be used for providing workouts. The system includes a plurality of units, or “cones,” which may be placed on a field. The units are in wireless communication with a hand-held device, which may facilitate the setting up and running of workouts. In one embodiment, the units are placed in a layout on a field, and a sequence of units is actuated to signal the user to move towards particular units. The units also contain devices that sense the presence of the user. In certain embodiments, the system modifies the pattern during a run using an artificial intelligence algorithm. In other embodiments, the units include devices that may be used to trilateralize the positions of the devices using acoustic ranging.

### CROSS-REFERENCE TO RELATED APPLICATIONS

This application claims the benefit of U.S. Provisional Application No. 61/895,296, filed Oct. 24, 2013, the contents of which are hereby incorporated by reference in its entirety.

### BACKGROUND OF THE INVENTION

1. Field of the Invention

The present invention generally relates to systems and method for physical training, and more particularly to a system and method of providing a user with a course to complete by running to sequentially actuated units on a field and providing a score based on how rapidly and accurately the user completes a course.

2. Discussion of the Background

The training of athletes for sports typically involves the running of certain patterns on a field, where the pattern is formed from a sequence of stations that the athlete must run to. This type of training has historically been performed by setting out cones on a field, and there are more advanced versions that use electronic devices within the cones to sequentially signal the athlete.

While this method of training is well known, it suffers from several deficiencies. First, the pattern to be run is decided ahead of time. This does not provide training in response to actions in the field, as occurs during a game or a scrimmage with other players, and thus is of limited use.

Second, setting up new patterns can be difficult, and depending on the layout may require repeated measurements. This difficulty limits the number of different layouts which might be used during training.

Third, even with automated systems, the exact placement of cones is not necessarily known with accuracy, this limiting the ability to determine running speeds.

Thus there is a need in the art for a method and apparatus that permits for more flexible workouts, including providing more layouts and patterns for training athletes. Such a method and apparatus should be easy to operate, should provide for quick and accurate placement of cones, and should provide useful workouts and information which the athlete may use to improve their performance.

### BRIEF SUMMARY OF THE INVENTION

The present invention overcomes the disadvantages of prior art by providing units for placing on a field that are part of a computer controlled system. In certain embodiments, the each unit includes devices or means for signaling the user to run towards the unit and devices or means for determining when the user has approached the unit. The system also includes the ability to determine the performance of the user and modify the pattern while it is being run.

In certain other embodiments, the units are equipped with devices for determining the distance between units and the system has the computational capability of determining a map of the layout.

Certain embodiments of the present invention overcome the limitations and problems of the prior art by providing a pattern that responsive to user performance;

Certain other embodiments of the present invention overcome the limitations and problems of the prior art by automatically determining the placement of units on a field.

Certain embodiments provide a system for executing a training run of a user in a field. The system includes two or more units arranged in a layout on the field, where at least two of the two or more units includes a device for signaling the user and a device for determining the proximity of the user to the unit, and a programmable computing device programmed with a pattern for executing the training run, where the pattern includes a sequence of when one or more of the two or more of the plurality of units provides a signal to the user. The programmable computing device is further programmed to modify the pattern during the training run.

Certain other embodiments provide a method for executing a training run of a user in a field utilizing a programmable computing device. The device is programmed for sending a sequence of instructions to one or more units of a plurality of units on the field, where each instruction causes the unit to generate a signal for the user; determining the time between the generating of the signal for the user and the time required for the user to reach the proximity of the unit generating the signal; and modify the sequence of instructions during the training run.

Certain embodiments provide a system for providing a layout of units for training a user in a field. The system includes two or more units for placing on the field, where the system includes means for trilateralization of the position of units on the field; and a programmable computing device including a memory storing a predetermined layout of the two or more units. The programmable computing device is programmed to prompt the user to place the two or more units at locations corresponding to the predetermined layout.

Certain other embodiments provide a method for placing units on the field for training a user using a programmable computing device. The method includes providing a map on a display of the programmable computing device, where the map includes a predetermined layout of two or more units on the field; prompting the user, with the programmable computing device, to place units on the field according to the provided map; determining the actual placement of units on the field by trilateralization; and prompting the user to move units on the field according to the predetermined layout.

These features together with the various ancillary provisions and features which will become apparent to those skilled in the art from the following detailed description, are attained by the system and method of the present invention, preferred embodiments thereof being shown with reference to the accompanying drawings, by way of example only, wherein:

### BRIEF DESCRIPTION OF THE SEVERAL VIEWS OF THE DRAWING

FIGS. 1A and 1B are schematics of a plurality of units placed on a field for athletic training, where FIG. 1A illustrates communications between control units and a hand-held device; and FIG. 1B illustrates communication between control units and drone units;

FIGS. 2A-2D are views of units of FIGS. 1A and 1B, where FIG. 2A is a perspective view of a unit; FIG. 2B is an elevational view of a unit, FIG. 2C is a top view of a unit, and FIG. 2D is a side view of a unit with the legs folded up for storage;

FIG. 3 is a schematic of the components of a unit;

FIG. 4 is a flowchart showing various functions of performed by the hand-held device;

FIGS. 5A-5D illustrate the display of the hand-held device used to select a layout and specify a pattern, where FIG. 5A presents a list of stored layouts, FIG. 5B presents a pattern editor, FIG. 5C allows a user to select a station, and FIG. 5D allows a user specify station parameters;

FIGS. 6A and 6B illustrate the display of the hand-held device to define or modify a layout;

FIGS. 7A, 7B, and 7C is a flowchart illustrating one embodiment of a trilateralization scheme of the present invention;

FIGS. 8A and 8B illustrate the display of the hand-held device while locating the units during trilateralization, where FIG. 8A shows the user of the hand-held device in orienting the layout, and FIG. 8B shows the user being presented with trilateralization solutions;

FIG. 9 illustrates a game tree that may be used by an artificial intelligence algorithm;

FIG. 10 is a diagram illustrating one embodiment of AI In-Game Dataflow;

FIG. 11 is a diagram illustrating one embodiment of AI Server Dataflow;

FIG. 12 is a diagram illustrating a description of one embodiment of In-App functions;

FIGS. 13A and 13B show a first example of a game, where FIG. 13A is a view of the units and FIG. 13B illustrates the game logic;

FIGS. 14A and 14B show a second example of a game, where FIG. 14A is a view of the units and FIG. 14B illustrates the game logic;

FIGS. 15A and 15B show a third example of a game, where FIG. 15A is a view of the units and FIG. 15B illustrates the game logic; and

FIGS. 16A and 16B illustrate the use of the system for providing layouts and locating units on the field, where FIG. 16A shows the initial placement of the units and FIG. 16B shows a final placement of the units.

Reference symbols are used in the Figures to indicate certain components, aspects or features shown therein, with reference symbols common to more than one Figure indicating like components, aspects or features shown therein.

### DETAILED DESCRIPTION OF THE INVENTION

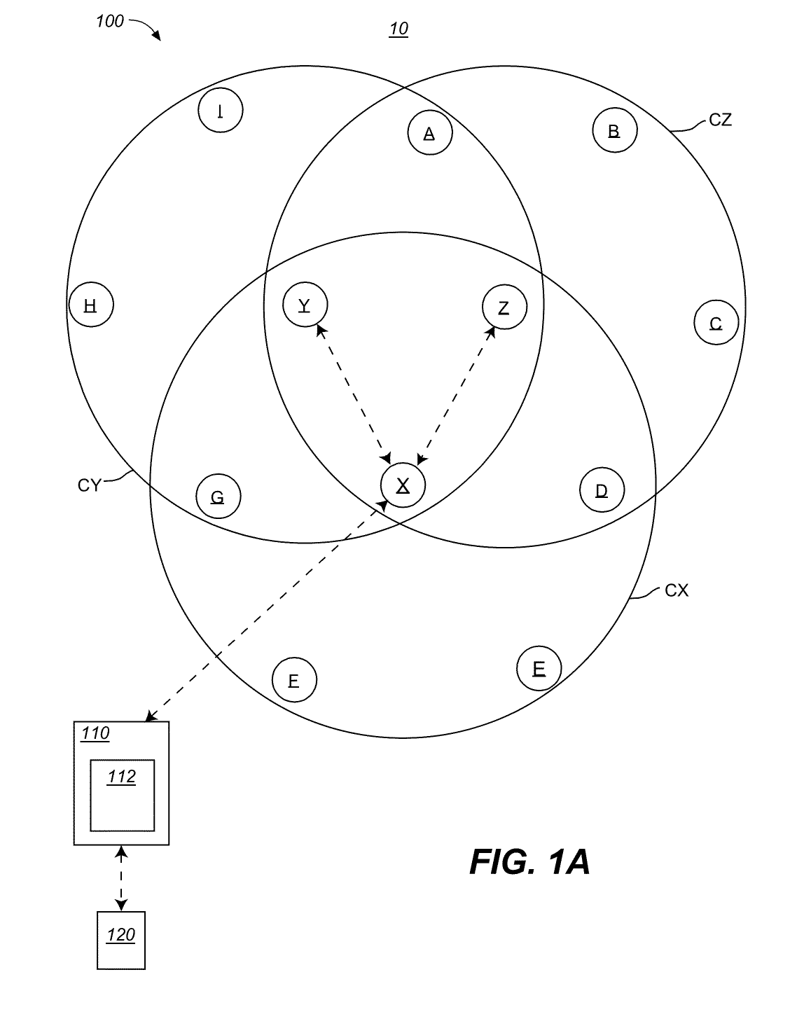

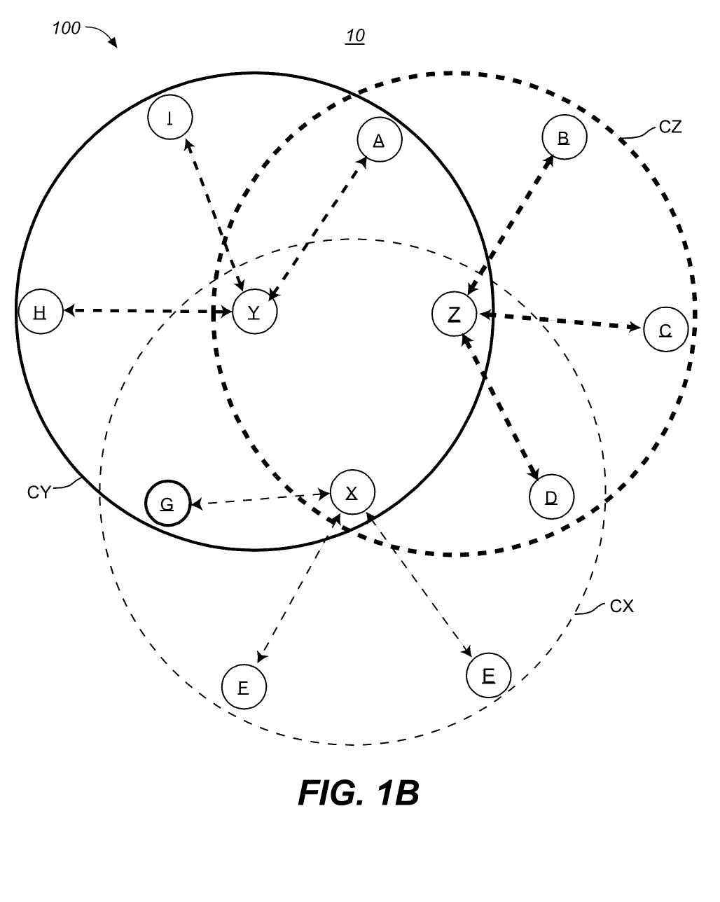

One embodiment of the present invention provides plurality of units which may be used for athletic training. For illustrative purposes, FIGS. 1A and 1B illustrate one such system 100 as a plurality of units 200, in an illustrative “layout” on a field 10 as units A, B, . . . , I, X, Y, and Z, a hand-held device 110 having a display 112, and an optional server 120 for storing and/or generating data. FIGS. 1A and 1B illustrate communications between hand-held device 110 and units 200 as: 1) communication between hand-held device 110 and unit X (in FIG. 1A), and 2) communication between unit X and units Y and Z (in FIG. 1A), and communication between units X, Y, and Z, and units A, B, . . . , and I (in FIG. 1B).

Hand-held device 110 may be, for example and without limitation, a remote control unit, or may be a smart phone, tablet or some other programmable device. For illustrative purposes, hand-held device 110 is shown a smart phone and the programming thereon for executing system 100 a smart phone application (or “app”). In general display 112 may be a touch screen display, where a user may provide input for wireless communication with unit X, which then wirelessly communicates with units 200.

Importantly, hand-held device 110 is capable of wireless communication with each unit 200, which may be, for example and without limitation, units X, Y, Z, A, B, . . . , and I. In the embodiment of FIGS. 1A and 1B, a chain of communications is shown between hand-held device 110 and unit X, which is referred to herein, without limitation, as a “master control unit,” and then to the other units, The units at the end of the chain of communications, which are for example and without limitation shown in FIGS. 1A and 1B as units A, B, . . . , and I, are referred to as “drone units.” Further, units Y and Z are intermediate units in the chain of communications with the drone units, and are referred to as “secondary control units.” It will be appreciated that this chain of communications is just one example of an embodiment of the present invention and, for example, secondary control units may not be present in certain embodiments, with the master control unit communicating directly with all the other, drone, units.

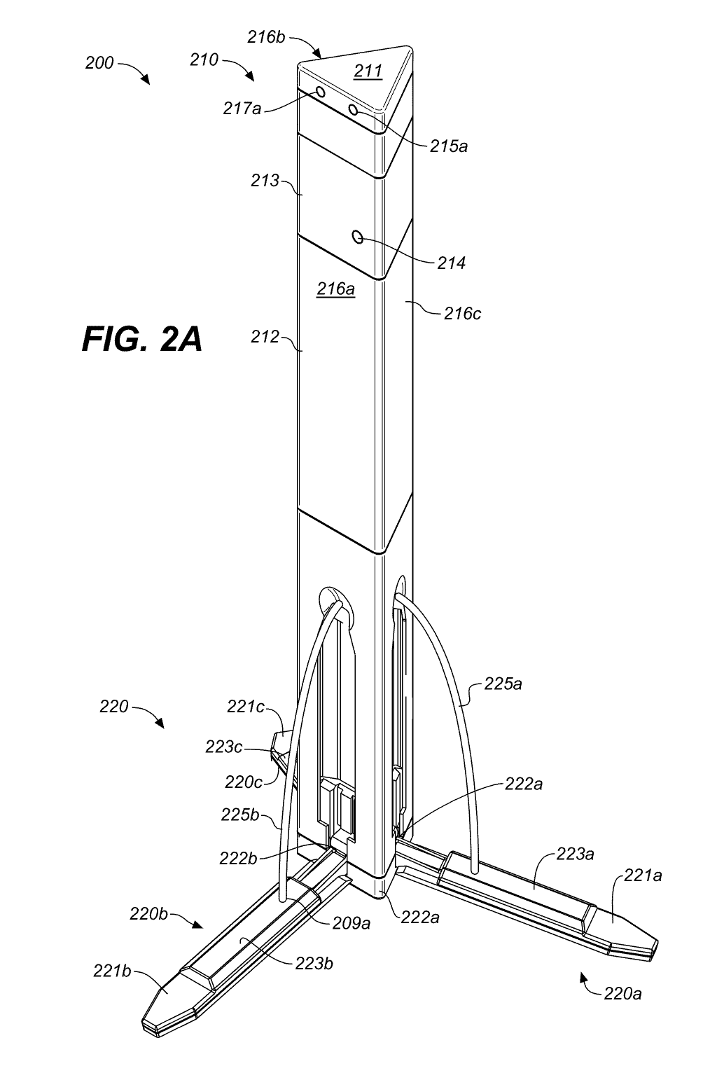

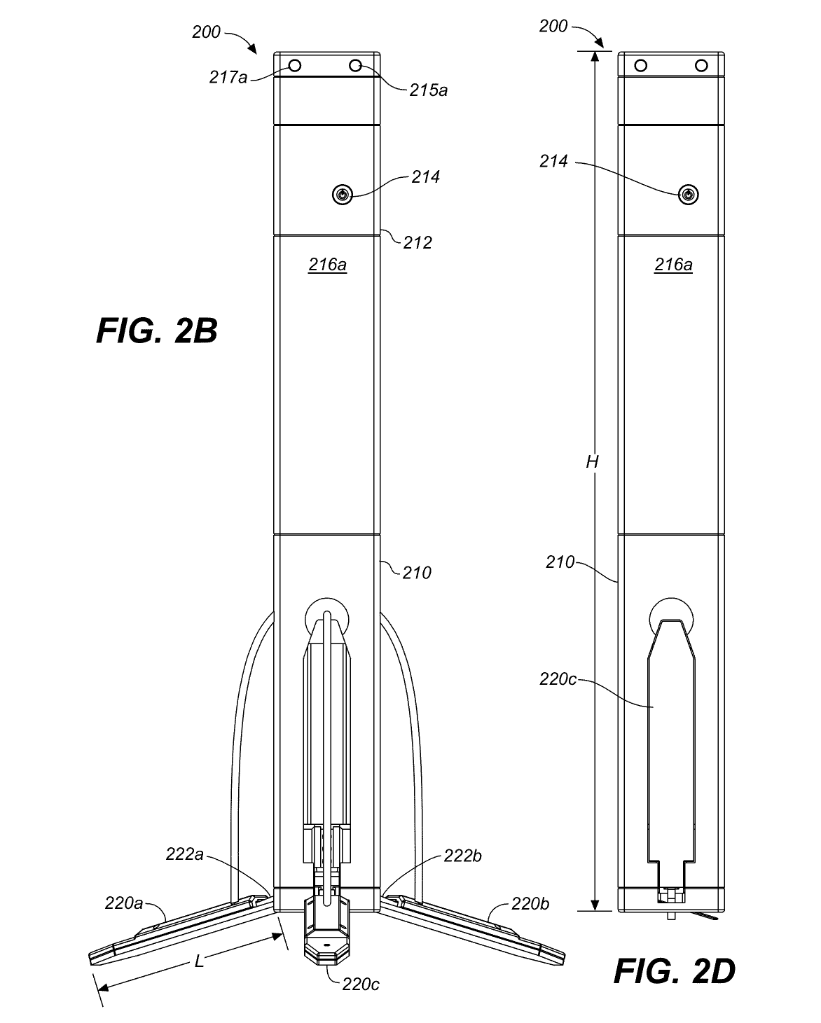

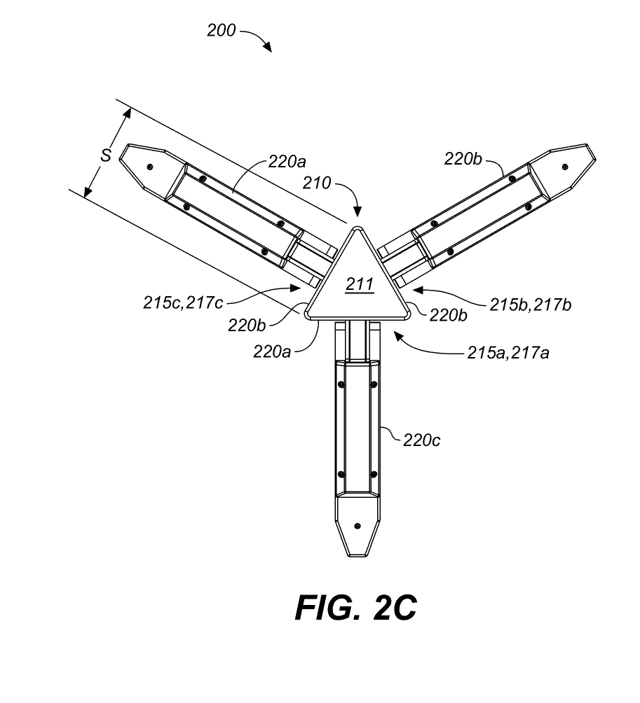

FIGS. 2A-2C show views of one embodiment of a unit 200, where FIG. 2A is a perspective view of the unit; FIG. 2B is an elevational view of the unit, FIG. 2C is a top view of the unit. As discussed subsequently, unit 200 may include, for example and without limitation, means for signaling a user (such as by sound or light), means for detecting an interaction with a user (such as by a touch or proximity sensor), and means for communicating with other units. System 100 includes a computing system that controls the sequence of signaling, which it termed a “pattern,” which may be in response to the detection of user, and transmits information back to hand-held device 110 for storing information regarding the user's training.

Each unit 200 is thus configured for wireless communication with the other units 200. Further, at least one of unit 200 is configured for communicating with hand-held device 110. It will be appreciated that the communications capabilities of units 200 may be identical, or, in certain embodiments, only one of the units is a master control unit, capable of communicating with hand-held device 110.

As is explained subsequently, system 100 is not limited to any number of units, any specific layout or pattern. For easy of explanation, each unit is described as containing the same components, with differences based on how the units communicate. It is understood, however, that there may be different types of units which cooperate in the same way as is described herein.

Further, the term “cone” may be used herein as being synonymous with for the term “unit.” The term cone is not meant to denote an actual shape of the unit, but is a term used in the art with reference to the units discussed herein.

More specifically, FIG. 1A illustrates communication between master control unit X and hand-held device 110 and secondary control units Y and Z, which are each within a communications range indicated by circle CX centered about master control unit X, and FIG. 1B illustrates communication between control units X, Y, and Z and drone units A, B, . . . , I. More specifically, a communications radius indicated by circle CY is centered about secondary control unit Y, and a communications radius indicated by circle CZ is centered about secondary control unit Z, and where master control unit X communicates with drone units E, F, and G; secondary control unit Y communicates with drone units A, H, and I; and secondary control unit Z communicates with drone units B, C, and D.

In the operation of system 100, units A, B, . . . , I, X, Y, and Z are placed on field 10 in a certain layout, and the units are activated sequentially according to a pattern, which may include a sequence of units and a target time for reaching the next unit. Thus for example, a user may use an app on hand-held device 110 to choose or arrange a layout and pattern. The layout, which matches how the units are arranged on the field, and pattern indicating a sequence of units, are then provided to master control unit X, which provides instructions to the other units for signaling a user, and which collects timing information from units A, B, . . . , I, X, Y, and Z for later processing.

The pattern may either be a predetermined pattern of units, or may be altered in response to the progress of the user. In this way, a user may be instructed to move through a training course and timing information on the progress through the course may be monitored.

A view of an illustrative unit 200 is shown in FIGS. 2A, 2B, 2C, and 2D as having an upright portion 210 having a housing 212 that includes 3 sides, 216a, 216b, and 216c, a power switch 214, and a plurality of legs 220, denoted as leg 220a, 220b, and 220c attached to the housing by hinges 222a, 222b, and 222c, and supports 225a, 225b, and 225c, respectively. Unit 200 includes one or more sensors, such as touch sensor 211 on upright portion 210 and sensors 221a, 221b, and 221c on legs 220a, 220b, and 220c, respectively, and lights 213 on upright portion 210 and lights 223a, 223b, and 223c on legs 220a, 220b, and 220c, respectively. Upright portion 210 also includes speakers 215 located on sides 216a, 216b, and 216c and indicated as speaker 215a, 215b, and 215c, respectively, and microphones 217 located on sides 216a, 216b, and 216c and indicated as microphone 217a, 217b, and 217c, respectively.

In general, sensors 211, 221a, 221b, and 221c are means for determining the proximity of a user to the unit, lights 213, 223a, 223b, and 223c are means for signaling a user to move towards a unit, and speakers 215a, 215b, and 215c and microphones 217a, 217b, and 217c are means for trilateralization of the units using acoustic ranging.

As shown in FIG. 2B, legs 220 have a length of L which may be, for example, and without limitation, approximately 0.2 m, as shown in FIG. 2D, which is a side view of unit 200 with the legs folded up for storage, upright portion 210 has a height H which may be, for example and without limitation, approximately 0.7 m, and upright portion has an equilateral cross section with sides S which may be, for example and without limitation, approximately 0.1 m.

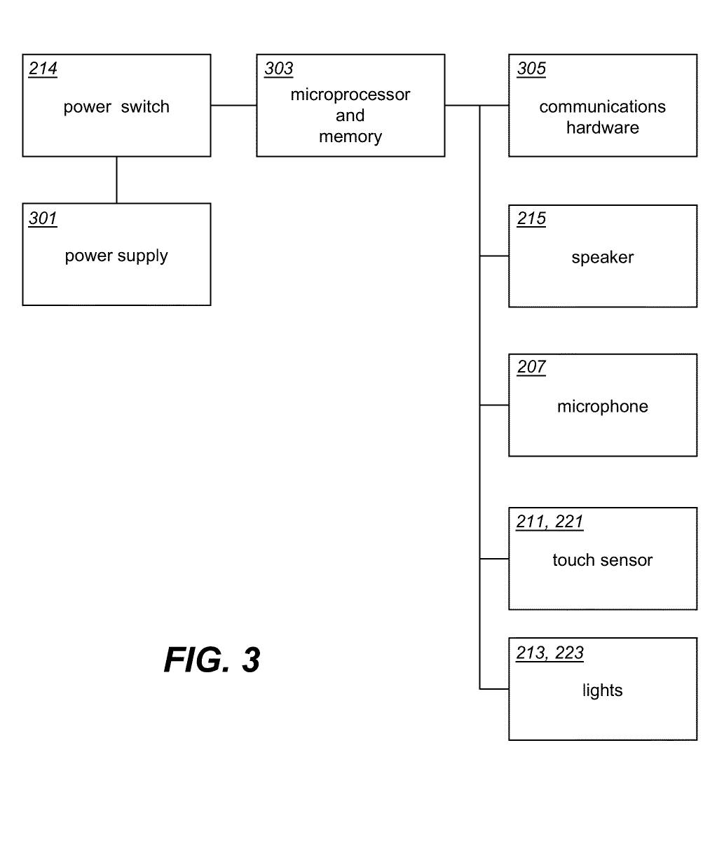

FIG. 3 is a schematic of components which may be present in unit 200. In addition to power switch 214, speaker 215, microphone 217, touch sensors 211 and 221, and lights 213, 224, unit 200 includes a power supply 301, a microprocessor and memory 301, and one or more communications hardware 205.

The components of unit 200 may include, for example and without limitation, the following: speaker 215 may be a model X-2629-TWT-R manufactured by PUI Audio (Dayton, Ohio), microphone 217 may be a model ADMP401, manufactured by Analog Devices (Norwood, Mass.), touch sensors 211, 221 may be a model AT42QT1010, manufactured by Atmel Corporation (San Jose, Calif.), lights 213, 224 may be a model WSD-5050A120RGB-X, manufactured by Wisdom Science and Technology (HK) Co. Limited (Hong Kong, China), power supply 301 may be a model TPP063048, manufactured by TRUE Power Technology Co., Ltd (Shenzhen, China), microprocessor and memory 303 may be a model Atmega328, manufactured by Atmel Corporation (San Jose, Calif.), and communications hardware 305 may include one or more of a model RN42 Bluetooth module, manufactured by Microchip Technology Inc. (San Jose, Calif.), a model NRF24L01+, 2.4 GHz RF transceiver, manufactured by Nordic Semiconductor (Oslo, Norway), and, for communications between trilateralization hardware, a model RFM12B wireless FSK transceiver module, manufactured by Hope Microelectronicsm Co., Ltd (Shenzhen, China) It is within the scope of the present invention to use other wireless communications protocols, and/or to use one protocol between all units. Further, it is understood that some components may be present in only some units 200. Thus, for example, only the master control unit, such as unit X, need communicate with hand-held device 110, and thus, for Bluetooth communication, only the master control unit need include a Bluetooth module. It is also understood that other protocols and hardware for wireless communication are within the scope of the present invention.

As noted above, certain units 200 are control units that delegate actions provided by wireless communication from an app on a hand-held smartphone 110 and which may also executes pre-set layouts and patterns. The control units may, in addition, orchestrate spatial relations of each drone unit by calculating data collected by trilateralizing the actual unit positions on the field, thereby mapping the positions of all units so that they accurately align with the layout created via the app. If synced properly, a control unit becomes a master control unit which interacts with other control units. Both the master control unit and other control units may act as units for a specific pattern and control drone units.

Thus, specifically, with power switch 214 on, microprocessor 301 is programmed to accept programming from hand-held device 110, to accept communications from communications hardware 305 for the activation of lights 213, 223 and to store, in memory 303, times between activation the lights and the activation of one of touch sensors 211, 221. The stored times may then be provided to master control unit X to perform calculations and rate the performance of the user. The time required for the user to transit from unit to unit is transmitted to the master control unit, which may then calculate distances and may assign points as a score for the execution of a pattern by the user. The master control unit may also indicate whether a user has completed the sequence or a portion of the sequence within prescribed, programmable time duration.

In the embodiment of FIGS. 1A and 1B, controls units X, Y, and Z conduct data exchange between hand-held device 100 and units A, B, . . . , I, X, Y, and Z, which may include but is not limited to the following functions: Layout Selection (that is, unit layout on the field); Pattern Creation; Allow User to Remotely Activate Units as the Athlete Runs; Speed; Volume; Sound Options; Record Sound Options; Impact and/or Sensor Actualization; Result Storage; and Upload Results to Online Account.

Pattern Creation options may include, for example, Create Athlete or Combatant Profile, Time of Course, Time of Splits, Distance Between of Run, Distance Between Each Unit, and/or Spatial Relation Between Each Unit.

Result Storage options may include, for example, Athletes' Profile, Athletes' Courses Ran, Athletes' Overall Times, Athletes' Splits, Athletes' Best Times, and/or Athletes' Best Splits.

Each of these types of data, with the exception of pattern creation, may also be programmed or accessed via the control unit.

In certain embodiments, each unit 200 may include one or more of the following: 1) at least one remote control transmitter/receiver (communications hardware 305); 2) the ability to record time of splits involving itself; 3) the ability to accept input from sensor 211, 221, and/or impact actuation; 4) flex spring mounted LED's designed to permit movement when impacted upon; 5) a telescoping padded pole for impact actuation, with the pole having a flex spring coupling attached to its base, to permit bending and returning to free standing without much force to the units; 6) stabilization with the ground by attaching either lawn stakes through the base or by attaching a weighed disc to the base; 7) multi-colored LED's indicating a lapse of time or to alert a specific athlete who is designated a color; 8) onboard speaker unit that can emit a variety of sounds, including options that are digitally recorded via the app. Examples of preprogrammed sounds may include: Fire Alarm, Gun Shot, Bell, Whistle, “Left Foot,” “Right Foot,” “Left Hand,” “Right Hand,” or “Go!;” and 9) other sensors which may include, but are not limited to, elements that may respond to a fist, weapon or firearm projectile.

In addition, units 200 are provided with components for trilateralization the position between all of the other units on field 10. Thus, for example, with power switch 214 on, microprocessor 301 is programmed to accept programming from hand-held device 110 that activates speakers 215 on one unit and record sounds from the speakers of the other units on the field in the other unit's microphones 217. The time delays between the speaker and each microphone is relayed to the master control unit, and from there optionally to hand-held device 110 or server 120, which may then calculate the distances between units. As discussed subsequently, other measurements may be require to accurately measure distance, such as time delays of electronics within individual units 200.

The timing of speaker activation and microphone readings are then sent to a memory of master control unit X for calculating the distance between each unit and a layout of the units. Trilateralization allows system 100 to determine the location of units 200, and is particularly useful for setting up a particular layout of units. Specifically, the setting up of units 200 may be tedious and error prone when using a tape measure or any method that involves manual measurement. The present invention measures the relative positions between each pair of units, which may be displayed on hand-held device 110 to allow for the display of a map of the actual locations of units and which may also provide an indication of where units should be moved to obtain a desired layout. Trilateralization also makes it easier to determine if the course is set up incorrectly, and insures that the data collected is accurate, as may be required for developing accurate/effective training algorithms. Distances may be calculated using 2D trilateration for a flat field, or 3D trilateralization if the field is not flat. Alternatively, a laser or GPS system may be used to determine unit location on the field.

Examples of the operation of units 200 will now be presented with reference to specific examples, which are not meant to limit the scope of the present invention. In one embodiment, hand-held device 110 and server 120 are used to set-up layouts—that is, indicated the placement and order of units 200 on the field, Hand-held device 110 may, for example, be a smartphone with an app that provides an interface with a control unit 200 via Blue Tooth. In certain embodiments, the app will enable users to control or program an array of options via a mobile device including, but not limited to: Layout Selection (that is, unit layout on the field); Pattern Creation; Allow User to Remotely Activate Units as the Athlete Runs; Speed; Volume; Sound Options; Record Sound Options; Impact and/or Sensor Actualization; Result Storage; and Upload Results to Online Account.

Pattern Creation options may include, for example, Create Athlete or Combatant Profile, Time of Course, Time of Splits, Distance Between of Run, Distance Between Each Unit, and/or Spatial Relation Between Each Unit.

Result Storage options may include, for example, Athletes' Profile, Athletes' Courses Ran, Athletes' Overall Times, Athletes' Splits, Athletes' Best Times, and/or Athletes' Best Splits.

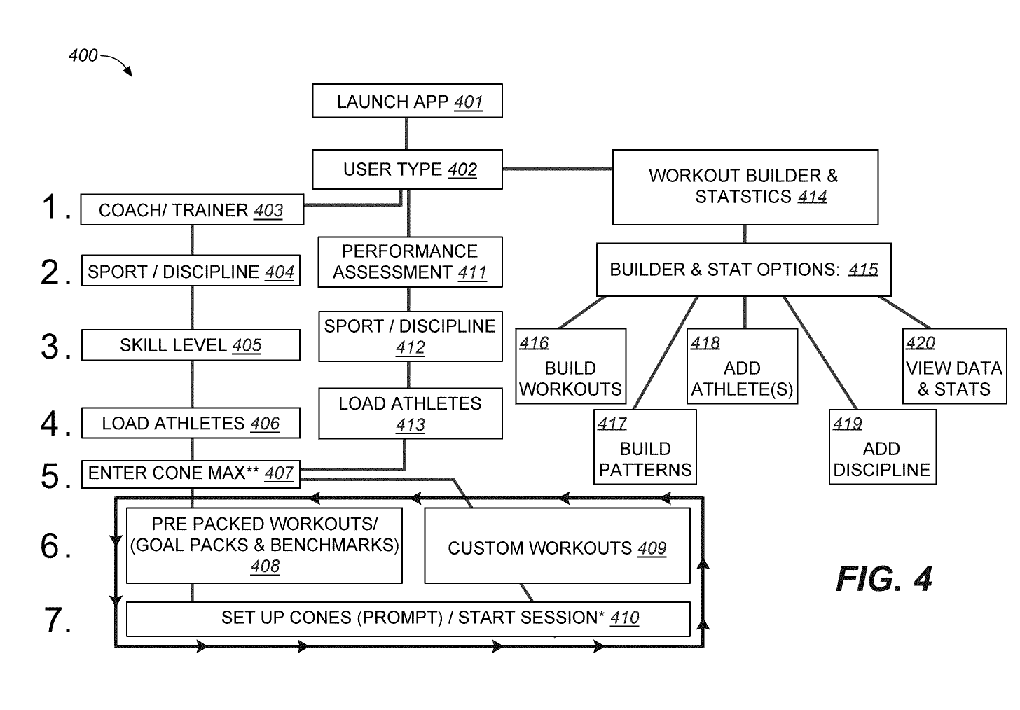

FIG. 4 is a flowchart 400 showing the user experience of an app on a smartphone hand-held device 110. In Block 401, the user starts the app. In Block 402, the user inputs the user type, which may be, for example and without limitation, a Coach/Trainer, a Performance Assessment, or a Workout Builder and Statistics. This selection directs the app next to one of Blocks 403, 411, or 414, respectively.

From Block 403 (“Coach/Trainer”), the app proceeds, in Block 404, to request to the selection of a specific sport or discipline. The selections here may be, for example and without limitation, basketball, football, soccer, combat, or fitness.

Next, in Block 405, the app requests the selection of a skill level, which may be, for example and without limitation, beginner, intermediate, advanced, expert, or superhero.

Next, in Block 406, the app allows for the input or selection of user (athlete) information. This information may include, but is not limited to the user's name, birthdate, height, weight or mass, gender, sport, position, skill level, and/or a photograph.

Next, in Block 407, the app requests the maximum number of units 200 that are available for the layout of a pattern.

Next, in Block 408 or 409, the app allows the user to select a specific workout, which may either be prepackaged (that is, including in the app), or custom designed, respectively.

Lastly, in Block 410, the user is prompted to set up the units and start the workout.

From Block 411 (“Performance Assessment”) the app proceeds, in Block 411, to request to the selection of a specific sport or discipline. This is similar to the selection described with reference to Block 404.

Next, in Block 412, the app allows for the input or selection of user (athlete) information. This is similar to the selection described with reference to Block 406.

The flow then proceeds to Blocks 407-410, as described above.

From Block 414 (“Workout Builder and Statistics”), the app allows the user several option (Block 415), which may include, but are not limited to, Build Workouts (Block 416), Build Patterns (Block 417), Add Athletes (Block 418), Add Discipline (Block 419), and View Data and Statistics (Block 420).

The following examples illustrate screen shots for different functions which may be controlled by hand-held device 110.

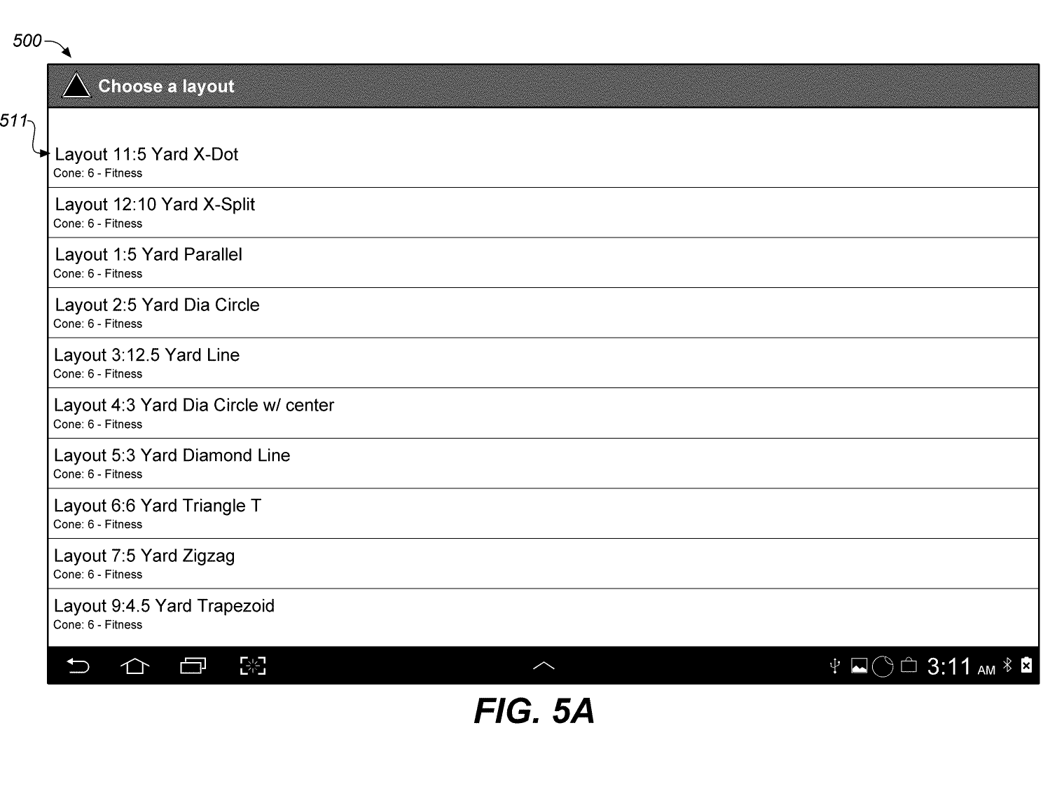

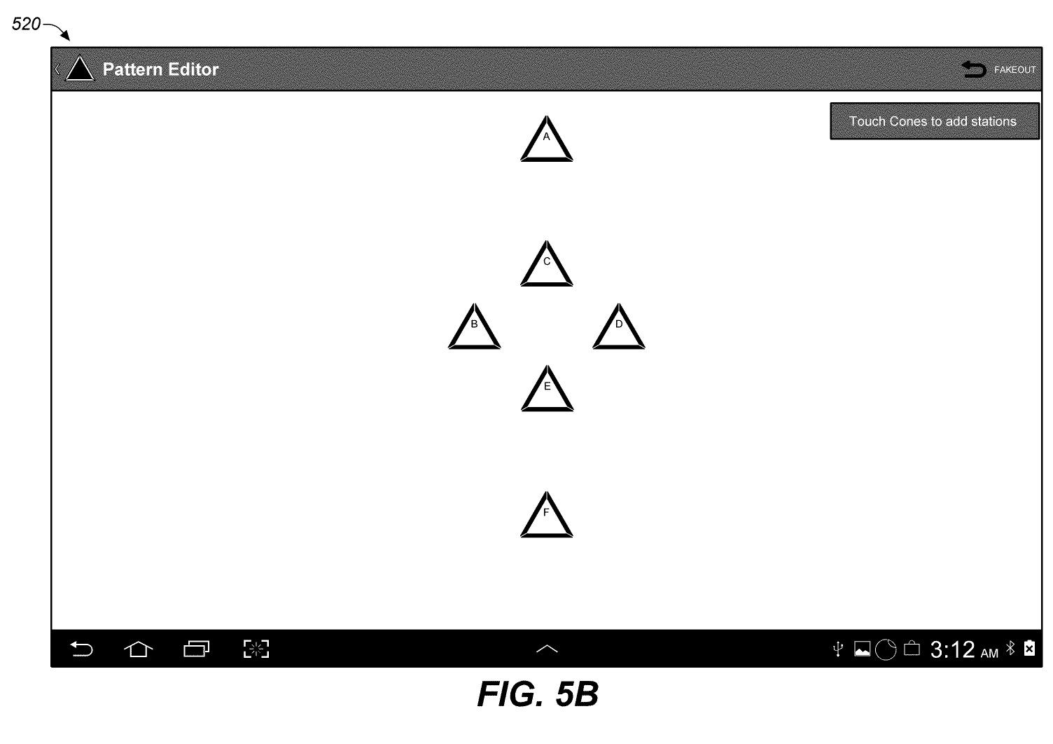

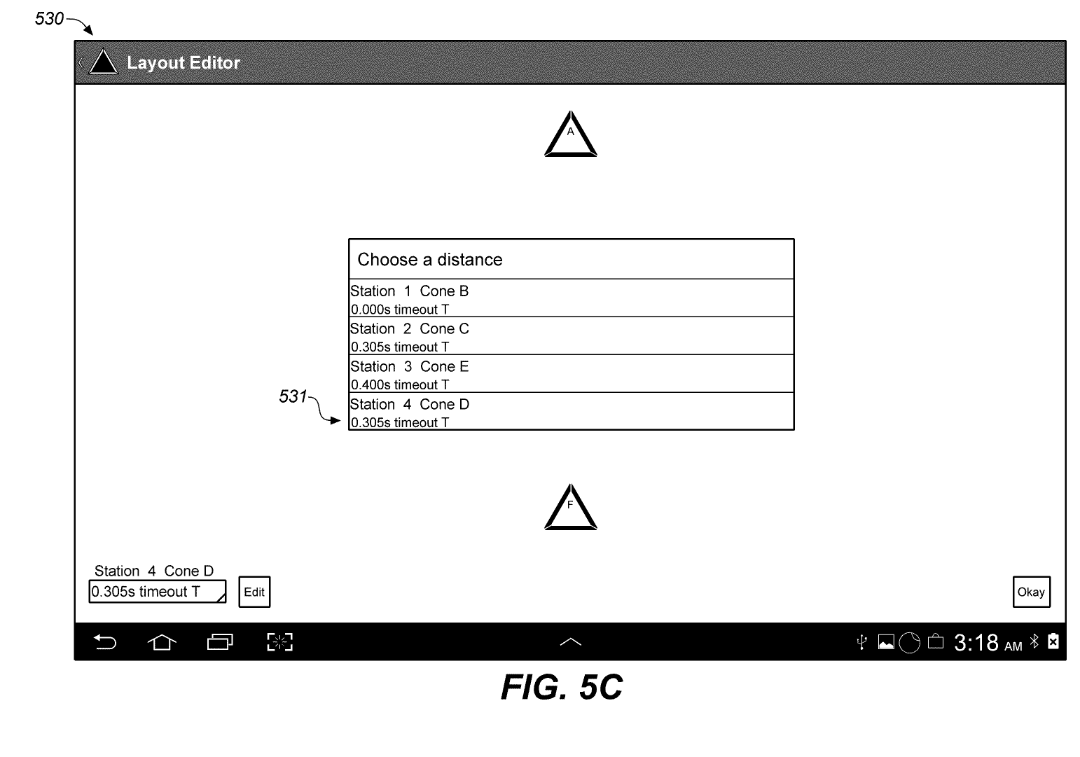

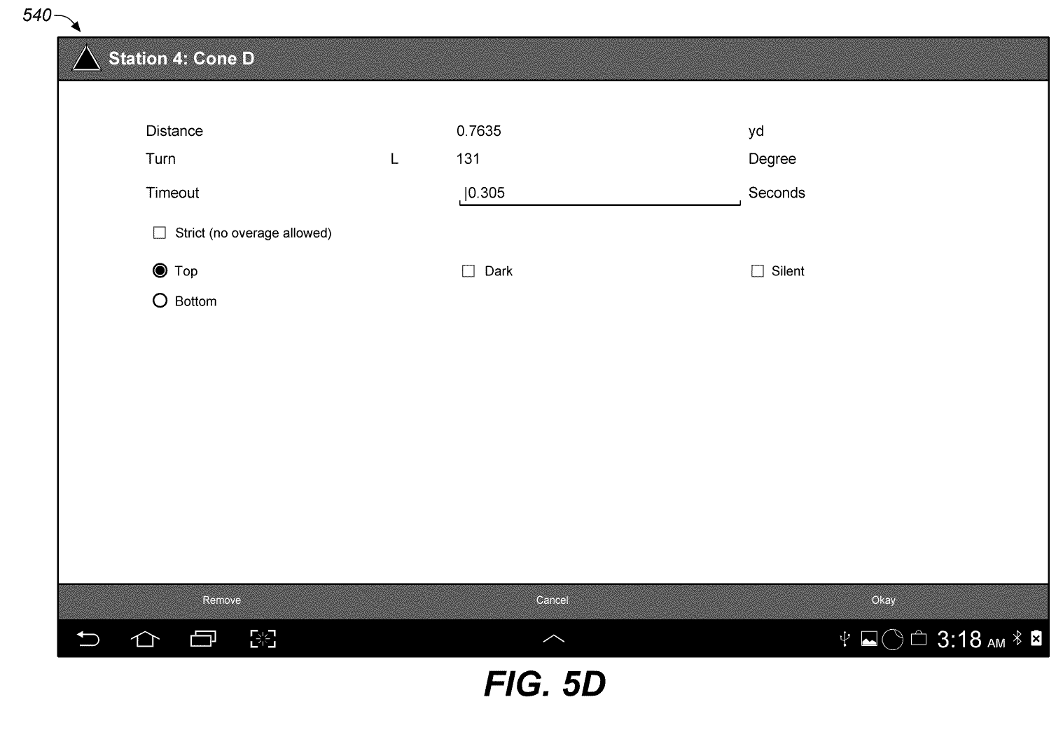

FIGS. 5A-5D illustrate the display 112 of the hand-held device 110 as used to select a layout and specify a pattern, as part of the function illustrated in chart 400, where FIG. 5A presents a list of stored layouts, FIG. 5B presents a pattern editor, FIG. 5C allows a user to select a station, and FIG. 5D allows a user specify station parameters.

FIG. 5A shows a screen shot 510 which provides a user with a list of pre-determined layouts. Each layout is given a number and name (such as layout 511, which indicates: “Layout 11: 5 Yard X-Dot”), the number of units (“cones”) required, and alternatively, an indication of the type of workout provided by the layout.

FIG. 5B shows a screen shot 520, which shows the selected layout and allows the user to indicate a pattern. Screen shot 520 thus shows, for example, units A, B, C, D, E, and F. The user may sequentially touch the representations of the units to set up a pattern, as a sequential list of units. Thus, for example, the user is prompted on screen shot 520, to touch a cone to add a station. This is an invitation to sequentially select units from the presented layout to select a pattern.

Once the pattern is selected, a screen shot 530, as shown in FIG. 5C is provided to enter information regarding the selected pattern. The user may then select a station, such as Station 4, Cone D, as indicted by the reference numeral 531. Next, a screen shot 540 is provided, as shown in FIG. 5D. From this screen, the user may input, for example, a timeout for reaching that station. By repeating the sequence provided by FIGS. 5C and 5D, a user may thus specify the particulars of the pattern.

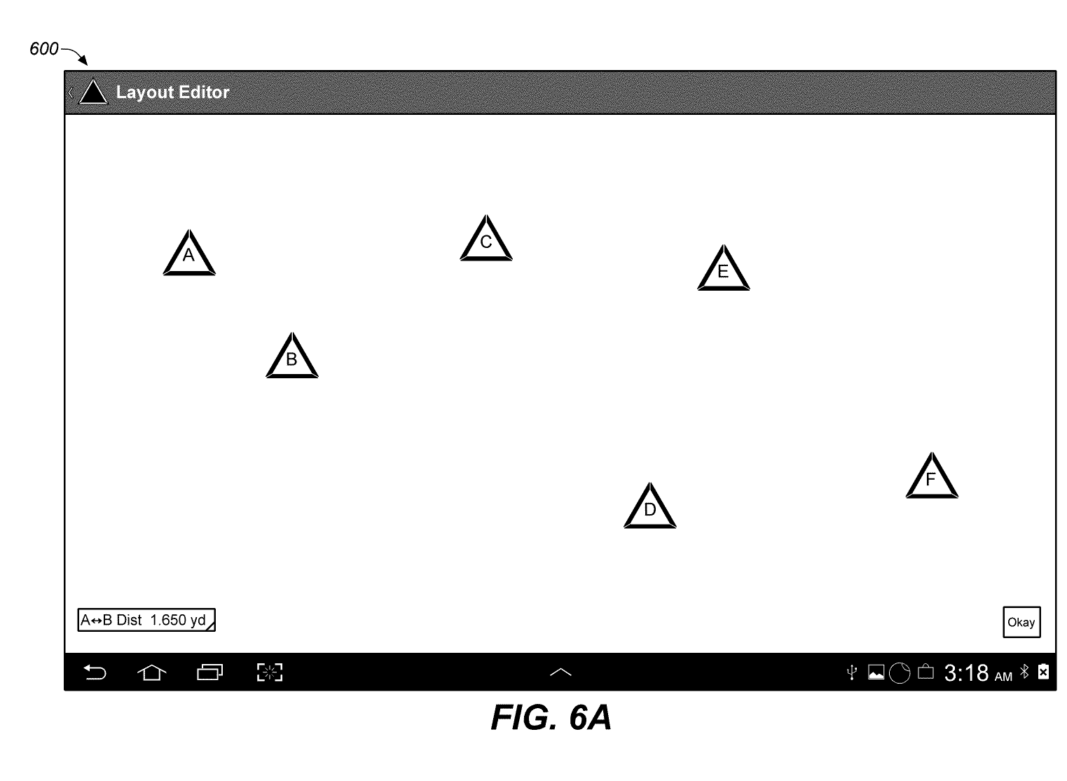

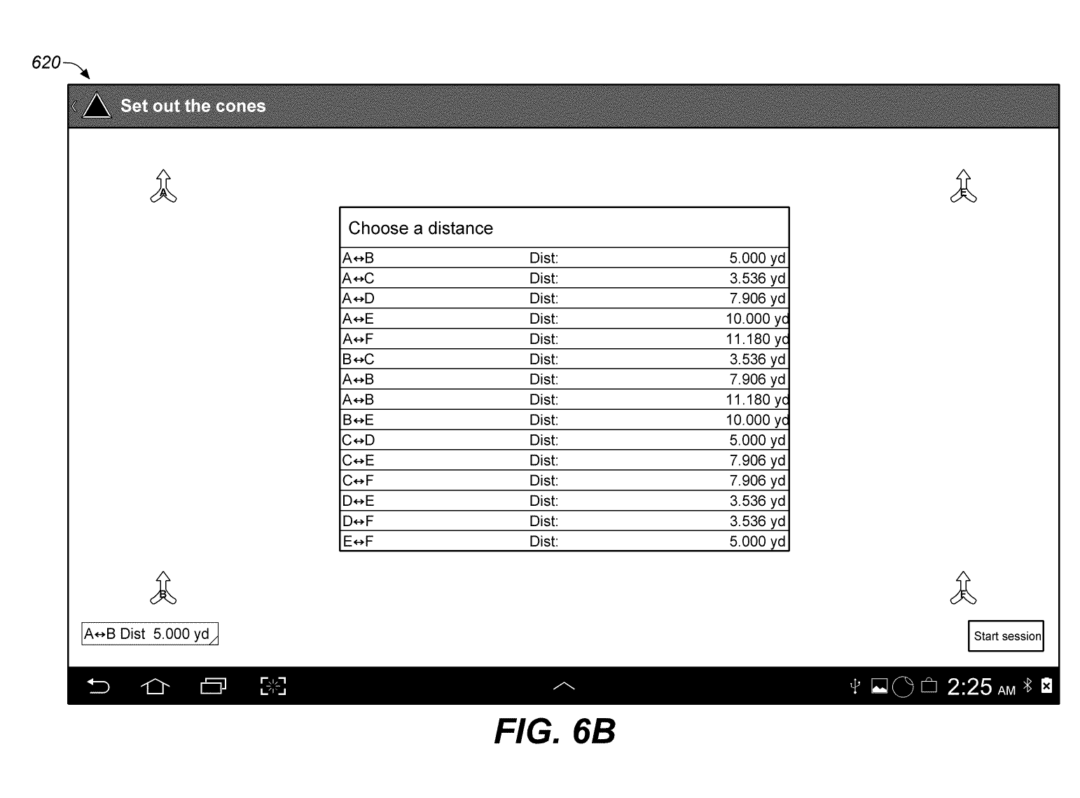

FIGS. 6A and 6B illustrate a screen shot 610 and 620, respectively, on the display 112 of the hand-held device 110 as used display of the hand-held device to define or modify a layout. Screenshot 610 shows a layout editor where, for example, a predetermined or user specified layout is provided. The user may tap on various units to view the spacing, as in the lower left hand corner of the screenshot, and may also touch to move units or rotate the pattern. Screenshot 620 shows the distance between various units. The user may user the layout image and distances as a guide for laying out the units on the field.

### Trilateralization

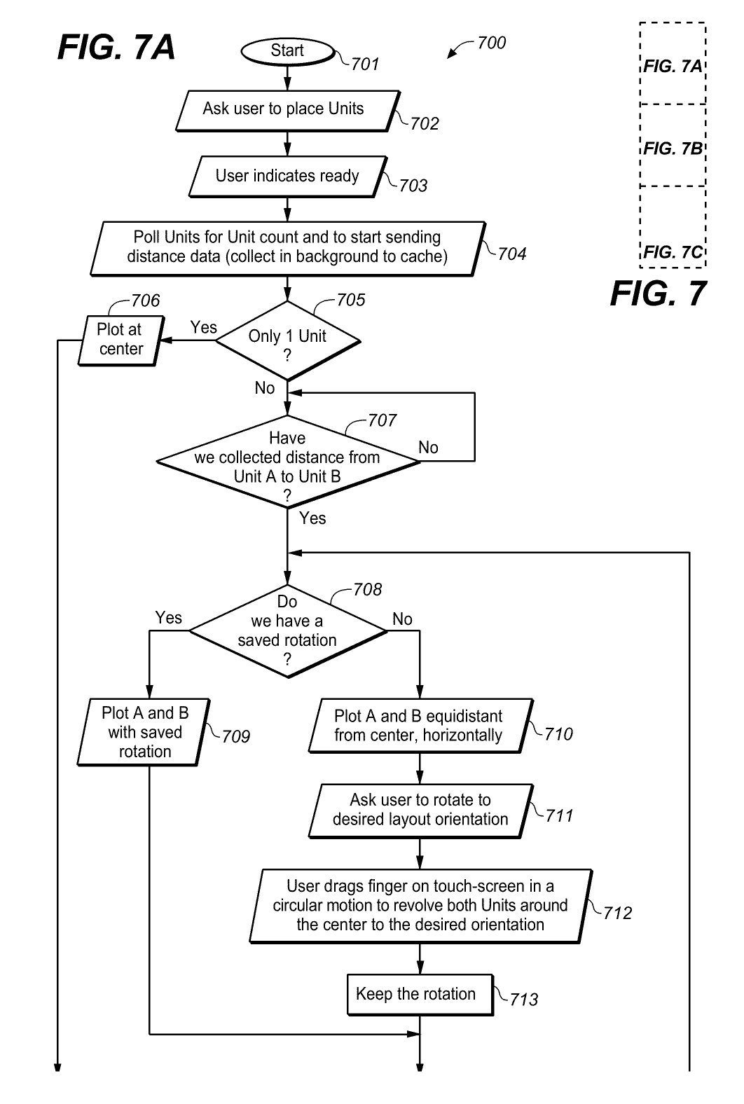

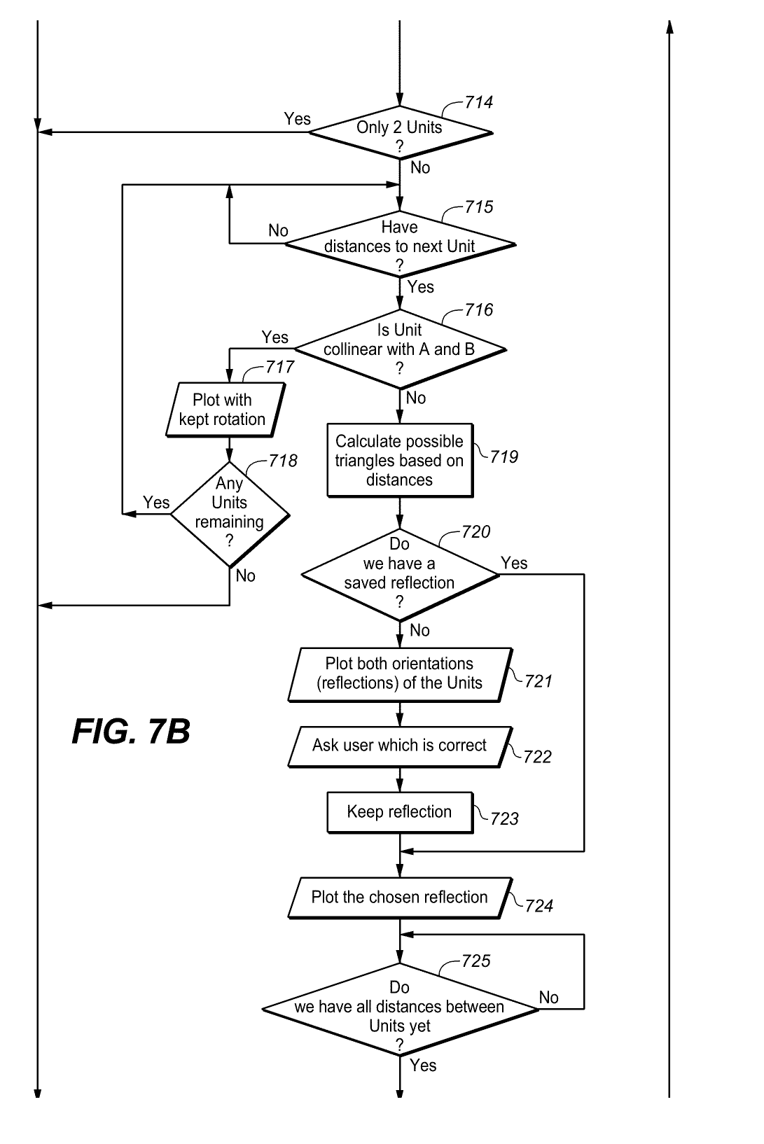

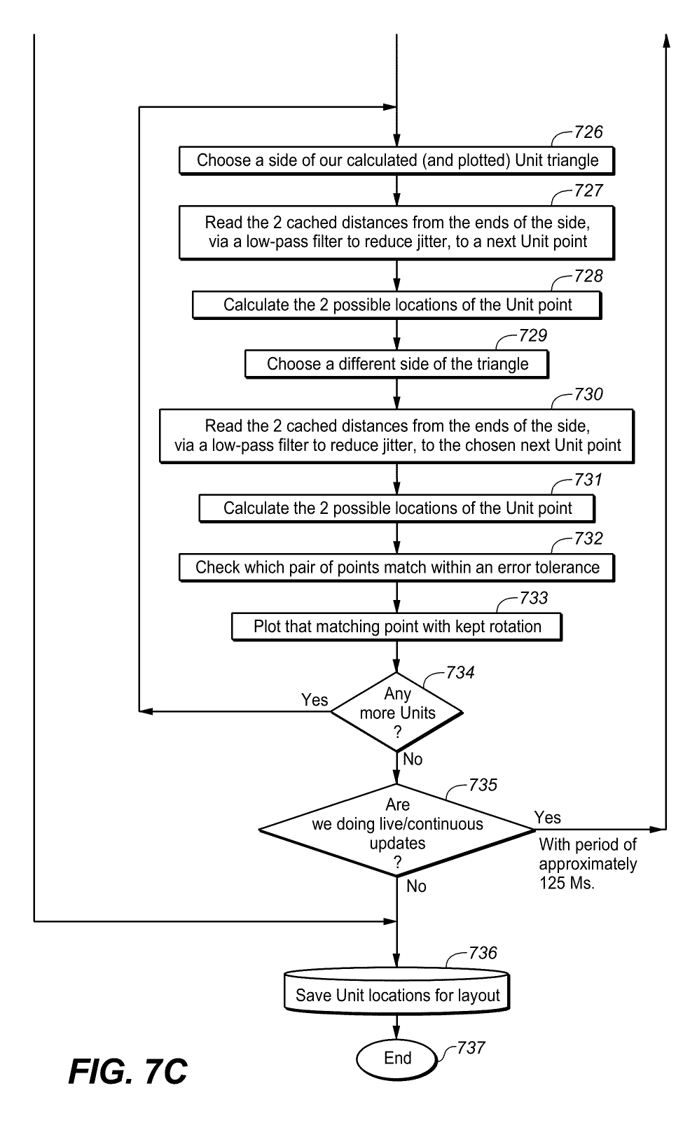

FIGS. 7A, 7B, and 7C is a flowchart 700 illustrating one embodiment of a trilateralization scheme of the present invention as Blocks 701-737. Flowchart 700 illustrates the interaction of hand-held device 110 with all units 200 that are placed in the field.

In general, trilateration is the well-known process of determining absolute or relative locations of points by measurement of distances, using the geometry of the locations. In the present invention, the distances between pairs of units is determined using acoustic ranging—that is, by sending acoustic signals between units and calculating a distance based on the propagation time and the speed of sound. With a sufficient amount of such information, trilateralization may produce a map of the relative locations. Since relative locations are determined, some ambiguities may exist that need to be resolved by user input to obtain a correct map. Specifically, the resulting map may not necessarily be correctly oriented in space. For units arranged on a plane, for example, trilateralization will produce 2 mirror image solutions—basically the process is not capable of determining if it is measuring a top view or bottom view of the map. In addition, Trilateralization is not generally capable of determining the proper orientation of the units—that is, locating north on the map. Both the mirror image and rotational ambiguities are addressed in the inventive method.

In certain embodiments, each unit 200 has a unique ID number and which a user may associate with a name of their choosing.

In Block 701, a user indicates on hand-held device 110 that they wish to begin trilateralization—that is, the operation of speakers 215 and microphones 217 on units 200 to determine the layout of units 200 on field 10.

In Block 702, display 112 provides a message asking the user to place all units 200 on field 10, and in Block 703, the user provides an indication on hand-held device 110 that the units are in place and ready for their positions to be determined. In certain embodiments, the user may place units 200 according to their own layout. In certain other embodiments, the user may select from a number of predetermined layouts, and the user attempts to place units 200 according to the predetermined layout. In Block 704, hand-held device 110 sends a signal to the master control unit, such as a unit X, to poll the units and to begin sending signals from their respective speakers 215. The master control unit has access to each units ID number, and in sequence, via each units' unique ID number, and sends sound from speakers 215 to each other unit to determine their distances. As each distance is determined it is sent to the master control unit which in turn sends it to the hand-held device which it caches for processing.

In Block 705, the master control unit attempts to communicate with other units via their IDs. If there is no response from a particular unit, system 100 then assumes that that particular unit unavailable for use. If hand-held device 110 or master control unit X determines if there is only one unit, then display 112 provides a screen with the sole unit at the center (Block 706), the unit's location is stored (Block 736), on hand-held device 110, and, alternatively, may also be stored on a server 120, and the trilateralization process ends (Block 737).

If Block 705 determines that there is more than one unit, then Block 707 repeats unit the distance between two units, noted as Unit A and Unit B, has been measured.

At this point, system 100 has determined a distance between Units A and B, but cannot determine their orientation relative to the user. If, in Block 708, it is determined that the orientation of Units A and B have been previously determined and saved, then display 112 is provided with a plot of Units A and B with the saved rotation, and the flow proceeds to Block 714, which is described subsequently.

If, in Block 708, it is determined that there is no saved rotation of Units A and B, as for example, from a previous trilateralization, then the user is prompted to indicate their orientation.

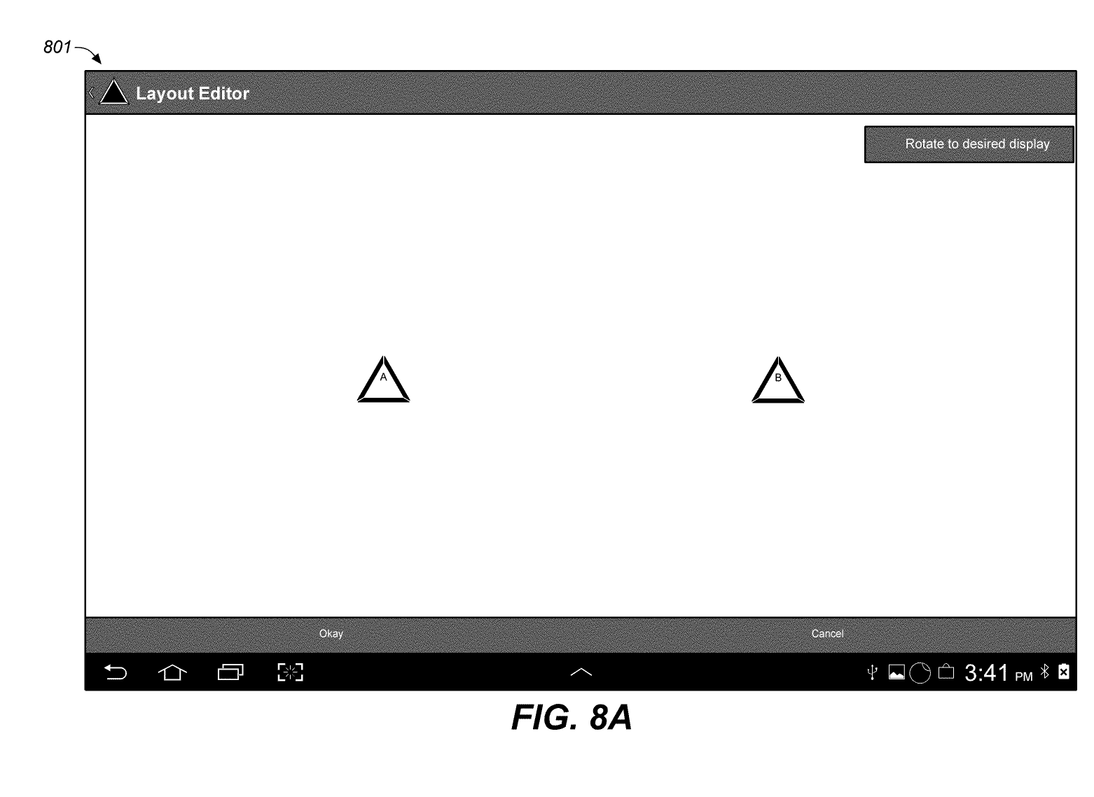

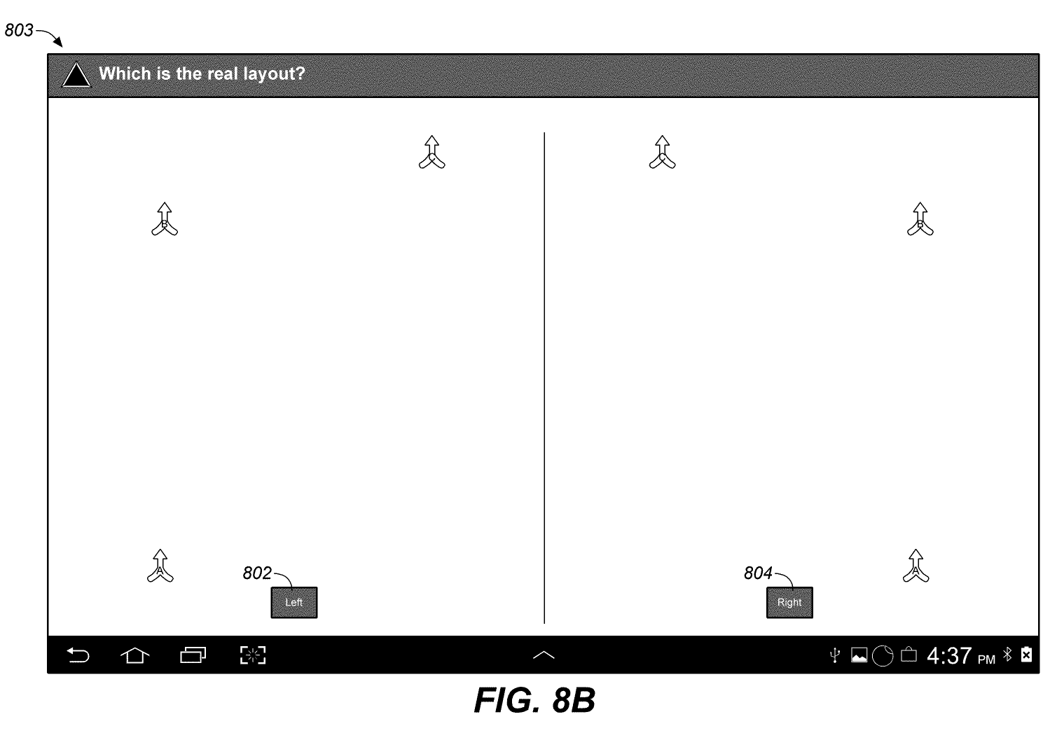

In Block 710, Units A and B are shown on display 112, in Block 711 the user is asked to provide an orientation of the units, and in Block 712 the user interacts with display 112 to orient the units. The action of Blocks 710-712 is illustrated in FIG. 8A as a screenshot 801 on display 112 which may be used in orienting the layout. Screenshot 801 shows Units A and B, and prompts the user to rotate the display so that the orientation corresponds to that orientation. The user may use arrow keys or touch and rotate the screen to affect a rotation of Units A and B about their center.

Once the orientation is entered, the rotation is saved (Block 713)

In Block 714, it is determined, as described above with reference to Block 705, if there are only two units in the field. If so, then the flow proceeds to Blocks 736 and 737, as discussed above, and trilateralization ends. If there are more than two units in the field, then flow proceeds to Block 715.

In Block 715, a next unit from all available units in the field (Unit C) is selected by hand-held device 110, and Block 715 repeats until it is determined in hand-held device 110 that the distance between Units A and C and Units B and C have been determined. Next, in Block 716, it is determined in hand-held device 110 if Units A, B, and C are collinear. If they are collinear, then the rotation determined above applies to Units A, B, and C. Unit C is added to the plot shown on display 112 with the same rotation (Block 717).

In Block 718, on hand-held device 110 determines if there are additional units to be trilateralizated. If there are no more units the flow proceeds Blocks 736 and 737, as discussed above, and trilateralization ends. If there are additional units, then flow proceeds back to Block 715, as described above.

If all units are collinear, then flow proceeds through Blocks 715, 716, 717, and 718 until all units are located.

If at least one unit is not collinear with all previous units, then flow proceeds from Block 716 to Block 719. The distance data may then be used by trilateralization routines, to layout the units on a plane.

At this point, there will be two possible solutions to the layout of the units. Specifically, the software will not be able to determine the correct layout of units from a mirror image of the layout. The user is then prompted, in Blocks 721-722 to indicate the correct reflection, or orientation, which is then saved in Block 723.

FIG. 8B illustrates a screenshot 803 on display 112 of hand-held device 110 prompting the user being presented with trilateralization solutions. Screenshot 803 presents a “left” image as a layout 805 and a mirror image (about the vertical) as a “right” image in a layout 807. The user may then click on box 802 labeled “Left” or box 804 labeled “Right” to select the correct layout of units on the field, and the flow proceeds to Block 724.

Alternatively, Block 720 may determine that there is a saved reflection, as from a previous execution of Block 723, and proceed from Block 720 to Block 724.

In Block 724, display 112 shows a plot of the units as observed on the field.

Block 725 then repeats until the distances between all pairs of units have been measured.

Once all the distances between units have been determined, Blocks 726 through 734 are executed for each unit. The measured distances may then be used by system 100, along with measured times, to determine the user's speed when running between sequential units.

Next, it is determined in Block 735 if it is required to continuously measure the layout of units. This may be required for one of two reasons 1) to allow users to move units while having the system update the displayed layout “live,” or 2) To allow the user to wait for a more desirable/accurate display. If continuous measurements are necessary, then flow proceeds back to Block 708. Since the rotation and orientation have been previously determined, these steps are not repeated subsequently. If Block 735 determines that no updates of unit position are required, then the flow proceeds to Blocks 736 and 737, as discussed above, and trilateralization ends.

System 100 has now determined the layout of units 200, allowing, for example, for a user's speed when running between consecutive units of a pattern to be determined.

In addition to determining the position of units placed on the field, an alternative embodiment allows a user to select a layout and then, after the user has placed the units in the field and the system has determined their positions, the system may check that the actual layout is close to the selected layout.

Thus, for example, a user first selects a layout from a stored selection of layouts, as shown and discussed above, for example and without limitation, in reference to FIG. 5A, and a selected layout is shown on display 112, as shown and discussed above with reference to FIG. 5B. Next, the user places units 200 in a layout to approximate what is shown on display 112.

Next, the trilateralization process is started in a continuous mode, as discussed above with reference to FIG. 7. As trilateralization proceeds, the user is prompted to rotate and reflect the display, as discussed above with reference to FIGS. 8A and 8B.

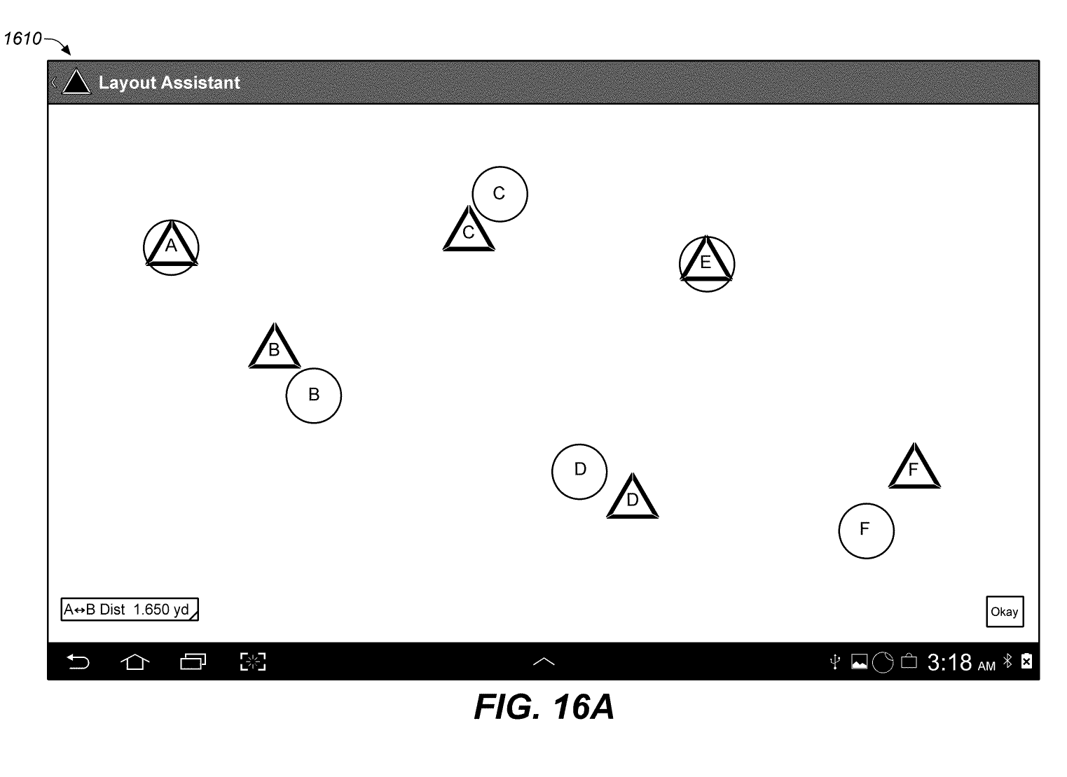

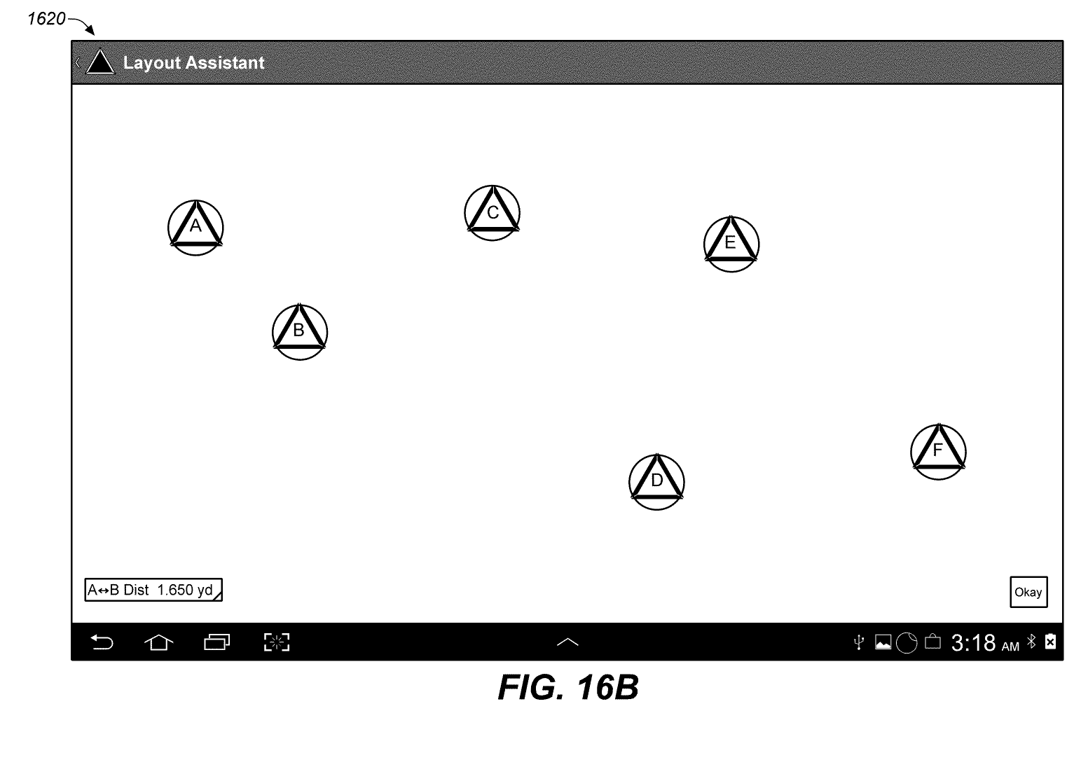

As the units are located from trilateralization, each appears on display 112. FIGS. 16A and 16B illustrate the use of system 100 for providing layouts and locating units on the field. Specifically, FIG. 16A shows a screenshot 1610 on display 112 of the initial placement of the units. System 100 has located, by trilateralization, each unit (indicated by letter in circles), and shows the location of each unit relative to the stored layout (indicated by letters in triangles). In FIG. 16A, several of the units (units A and E) are very close to the proper position, while others are not.

The user then adjusts the units on the field to obtain a layout that is closer to the selected layout, and then press the “okay” button when the desired layout has been achieved. In one embodiment, each circle blinks in proportion to how far each unit is from the selected layout position. The user may then move each unit until system 100 determines that the placement is accurate enough, say within the accuracy of the trilateralization measurement or some other metric.

FIG. 16B shows a screenshot 1620 on display 112 the adjusted position of the units, where each unit is properly placed for the selected layout.

### Artificial Intelligence (AI) Algorithm

In certain embodiment, the sequence and/or timing of a pattern may be determined or modified by a computer program using an artificial intelligence (AI) algorithm that operates on a combination of one or more of hand-held device 110, server 120, and one or units 200. Thus, for example and without limitation, the AI algorithm provides computer generated patterns to fulfill the training demand for each athlete. The basic design requirement for the system 100 is to support the online and offline environments. Hence, system 100 includes an in-app module and a server side module. The in-app module is responsible to select the best fit pattern for a specific athlete training request. The server side module is in control the pattern generation algorithm based on the collected athlete statistic data. Furthermore, a pattern-set data structure is used to communicate between the server and the in game module in order to direct the responses during the training process.

The differences between the pattern “mutation” process of in-app AI vs AI server is that the in-app AI can only modified the pattern based on the knowledge of single user performance, on the other hands, the modification process on the AI server using the knowledge among the global user performance.

In one embodiment, the AI algorithm is used for programming the system of the present invention, where a push system used to isolate the AI system as a separate element of the game architecture. This strategy takes on the form of a separate thread or threads in which the AI spends its time calculating the best choices given the game options. When the AI system makes a decision, that decision is then broadcast to the entities involved. This approach works best in real-time strategy games, where the AI is concerned with the big picture.

In general, at each difficulty level, the AI algorithm adjusts the performance requirement of a predefined pattern based on each user's initial ability. Thus, a specific tailored predefined pattern will be computed by the AI algorithm for each user at the start of training. Then, the AI algorithm will advance the pattern difficulty based on each user's run data. The AI algorithm may also identify the user's weakness by analyzing each run data, and adjusting the pattern performance requirement while guiding the user to achieve the overall training preferences.

Server-side software collects users' run data and includes the training feature of each predefined patterns base on the statistic relationship between users' performance and predefined pattern-set. The AI algorithm may include a neuron network that is designed to establish the relationship between the predefined pattern-set and users' run data. Once the training features have been identified, the AI algorithm will generate specific patterns to fulfill each individual's training preferences.

As more users' run data is collected, feedback from the AI algorithm will become more accurate.

When the user is in offline mode (not able to connect to server 120), an in-app AI algorithm provides new pattern suggestions based on the last evaluation information pull from the server. By combining these methods, system 100 intelligently provides feedback to the user base of his performance and training requirement.

Thus, for example, in certain embodiments, a layout and/or pattern is determined by an AI algorithm to provide the user with a more useful workout or training. The aim of the AI algorithm is to decide, at certain points during use, which branch of a pattern to direct the user. That is, the system attempts to force the user into taking moves that are at the ability level of the user (speed and accuracy).

### Pattern-Set Data

The AI algorithm of system 100 may include a pattern-set, which is a graph of the pattern data control by a set of transition conditions. The use of pattern-sets may be useful when connection to server 120 is not available.

The AI algorithm is responsible for intelligently formulate the pattern-set for different training scenarios. During each training session, the AI algorithm selects a suitable pattern-set for the specific athlete. The pattern-set may be considered as a computer generated training schedule which direct the athlete to reach his/her training goal. A simple linear pattern-set example is shown below:
Pattern A>Pattern B>Pattern C>Pattern D
   which each pattern (A, B, C, and D) having different difficulty level. Pattern-set can also be controlled by some transition conditions, for example,
Pattern A>Pattern B if athlete performs well with Pattern A
Pattern A>Pattern C if athlete performs bad with Pattern A
Pattern B>Pattern D if athlete finish Pattern B in time
Pattern D>Pattern E always

In addition, the transition between patterns is not limited at the end of each game. This design also allows the in game pattern transition:
Pattern A>Pattern A′
   if athlete performs well with first half of the pattern
Pattern A>Pattern A″
   if athlete performs not well with the first half of the pattern
Pattern A′>Pattern B always
Pattern A″>Pattern C always

The above example shows how a pattern-set describes in game transitions. The pattern transition can be suggested at any time during the game as long as the transition condition gets activated.

Using transition conditions, the AI algorithm is able to provide an interactive pattern suggestion base on the real time athlete's performance even using static pattern-set data.

### App and Dataflow

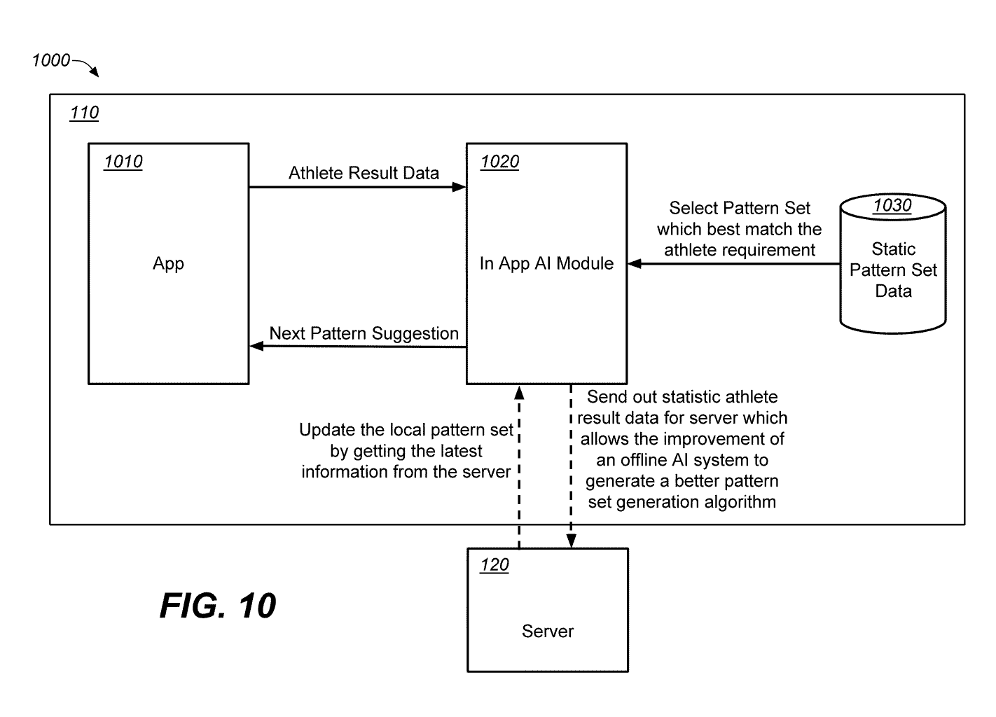

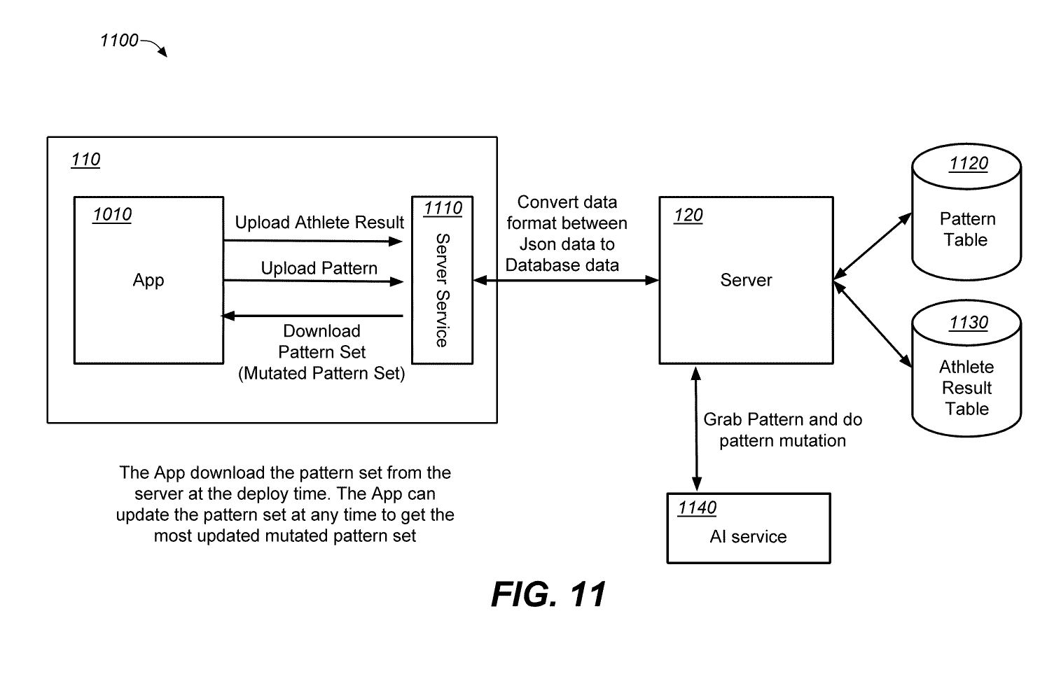

One embodiment of the app and exchange of information between hand-held device 110 and server 120 is illustrated in FIG. 10 as a diagram 1000 illustrating one embodiment of AI In-Game Dataflow and FIG. 11 as a diagram 1100 illustrating one embodiment of AI Server Dataflow.

As illustrated in diagram 1000, hand-held device 110 includes the app 1010, an in-app AI module 1020, and static pattern-set data 1030 stored in the memory of device 110. Diagram 1000 also indicates the flow of information between components: athlete result data flowing from app 1010 to in-app AI module 1020; next pattern suggestions from in-app AI module 1020 to app 1010; pattern-sets from static pattern-set data 1030 to in-app AI module 1020; updating pattern-sets from server 120 to in-app AI module 1020; and sending specific run data for an athlete from to in-app AI module 1020 to server 120.

As illustrated in diagram 1100, hand-held device 110 includes app 1010 and a server service 1110, and server 120 has access to pattern table 1120, athlete result table 1130, and AI service 1140, each of which may be part of server 120. Diagram 1100 also indicates the flow of information between components: uploading athlete result and uploading patterns from app 1010 to server service 1110, downloading pattern-sets from server service 1110 to app 1010, converting data formats between service 1110 and server 120, and server 120 having access to pattern table 1120, athlete result table 1130, and AI service 1140.

In-app AI module 1020 is in charge for choosing suitable pattern-set to respond the athlete requirement. In-app AI module 1020 retrieves a list of the most updated pattern-set data from server 120 at the application deployment time and stored is as static pattern-set data 1030. Then, stored pattern-set data 1030 will be selected for the athlete at the beginning of each training session. During the training, the sub-sequence pattern will be suggested base on the evaluation of the transition condition. If a connection to server 120 is available, in-app AI module 1020 may update the pattern-set data from the server locally to static pattern-set data 1030 to reflect any latest pattern changes.

In-app AI module 1020 may also provide results from pattern runs to athlete result table 1130 for later analysis. Examples of information stored in result table 1130 include, but are not limited to: tracking individual progress; recording runs and analysis of performance; comparison with other users. In addition, social networking software having access to athlete result table 1130 may allow users to find and challenge other users, compare results with other users, discover new patterns and configurations, participate in competitions, and follow friends and their activities, join clubs or create new clubs.

Server 120 thus acts as the facility to organize all submitted pattern globally. FIG. 11 is a chart illustrating the AI server module 1100. Module 1100 provides an interface for the in-app AI module to exchange the machine generate pattern-set and the athlete performance result information.

Each manually predefined pattern on the AI server will go through a “mutation” process to generate a group of mutated child patterns. Then, the mutated child patterns will be organized by their properties and used during the creation of a new pattern-set.

Furthermore, the AI server also acts as a platform for the AI system to process the statistic of the athlete performance information. That information is constantly monitored to dynamically affect the “mutation” process.

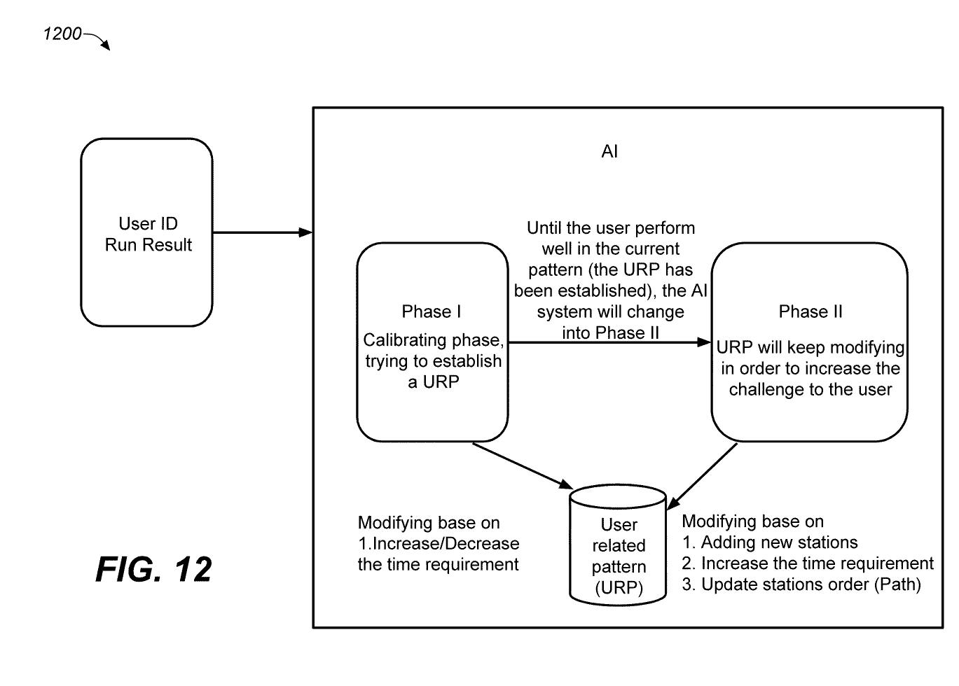

FIG. 12 as a diagram 1200 illustrating a one embodiment of an In-App Description. Diagram 1200 illustrates two different “phases.” In Phase I, the AI algorithm attempts to establish a pattern for a specific user (a User-Related Pattern, or URP). In Phase I, the AI algorithm will only modify the last (most recently executed) pattern time requirement unit the user can adequately execute the pattern. Once this has been accomplished, the AI algorithm executes Phase II. In Phase II, the AI algorithm modifies the URP by: 1) adding new stations, where a “station” is a point in a pattern traversal, generally where the user would touch a sensor on a unit. However a False Alert/Fakeout station is still a “station” even though the user usually never activates the sensor. The distinction between a “station” and a “unit” is important because any unit can be used more than once in a pattern, e.g. A->B->A->B->C->D->C where there are four units, but the pattern consists of seven “stations.”); 2) increasing the time requirement (by, for example, decreasing the time allowance between stations); and 3) changing the pattern, such as the movement between stations or changing the required action (alerts, for example) for a station. After each modification in Phase II, the AI algorithm will wait for the user to perform satisfactorily before increasing the difficulty.

In one embodiment, the AI system to make meaningful decisions, it uses unit locations and player interaction with units to perceive its environment. This perception can be a simple check on the position of the player entity. As systems become more demanding, players' performance will identify key features of the game world, such as viable paths to run, speed of time cycle, obstructions and number of obstructions.

The following is a list of features which may be part of the AI system.

In one embodiment, each pattern has set max score. Thus, for example and without limitation, 5 points may be awarded as a score for the completion of an action within a certain amount of time or with a certain speed, as calculated from trilateralizated distances. In another embodiment, one point is subtracted for every 0.1 seconds taken over the set time. Possible actions include, but are not limited to:
a. Speed Cutting Right
b. Speed Cutting Left
c. Speed Blind Side Going Left
d. Speed Blind Side Going Right
e. Speed Between Units in general
f. Speed of Triangular Patterns
g. Speed Stop and Go
h. Speed of Angled Approach
i. Speed of 180
j. Speed Lateral Left
k. Speed Lateral Right

The performance of these actions will help to determine the final score. The score consist of multiple parts
1) Set Performance Level (Light cycle speed and the number of Obstructions used)
   a) Light Cycle Speed
      i) Beginner
      ii) Intermediate
      iii) Experienced
      iv) Professional
   b) Obstructions
      i) Silent Alert
      ii) Dark Alert
      iii) False Alert
      iv) Run Backwards
      v) Reverse Your Course
      vi) Decision Point
      vii) Vector speed
      viii) The player's weakness
   c) Overall Distance Ran
   d) Accuracy

A set of preset behaviors may be used to determine the behavior of game entities. For example, if a player consecutively scores high between 3 reaction points, the AI system may always force the player to change directions 180 degrees. More complex systems may include a series of conditional rules. The tactical component of our AI system uses rules that govern which tactics to use. The strategy component of our AI system uses rules that build orders and how to react to conflicts. Rules-based systems are the foundation of AI. These methods for designing the AI system fit into the predefined events of our game. However, when more variability and a better, more dynamic adversary for the player, the AI will be able to grow and adapt on its own.

The adaptive learning mechanics are deep and the options for gameplay are innumerable. To provide a constant challenge for the player without the player eventually figuring out the optimal strategy to defeat the computer, the AI learns and adapts.

Our basic method for adaptation is to keep track of past performances and evaluate their success. The AI system keeps a record of performances and choices a player has made in the past. Past decisions are evaluated. Additional information about the situation can be gathered by the coach or personal trainer using the product to give the decisions some context.

This history will be evaluated to determine the success of previous actions and whether a change in tactics is required. Until the list of past actions is built, general tactics or random actions can be used to guide the actions of the entity. This system can tie into rules-based systems and different states.

In a tactical game, past history will decide the best tactics to use against a player.

The AI system may identify points of interest on the field, and then figures out how to get players to go there. These methods are optimized by providing ways of organizing them in a way to account for multithreading. The AI algorithm is able to perceive its environment, navigate and move within the field of play.

Everything in the playing field is a known quantity: There are lists or maps in the game with everything that exists in it, its location and all possible moves of the player. The intelligent agent can search those lists or maps for any criteria, and then immediately have information that it can use to make meaningful decisions.

Sight is given to our intelligent agent for perceptive ability. It does this by searching list of entities for anything within a set range. It can either get the first thing at random or it can get a list of things in range so that our agent can make the optimal decision about its surroundings.

This setup works well for the simple games. For a more complex style of game, such as a strategy or a tactical game, the AI system will need to be a bit more selective in what it “sees.” For example decisions based on ‘vector points and blind spot’:
1. Calculate the speed of player between two vector points
2. Calculate the angle of that vector points, the angle of surrounding units and the direction in which your agent ‘should be looking’
3. If the value of the player's speed is greater than the agent's preset speed limit, our agent will send the player to the most difficult corresponding unit outside of the player's line of vision.

The role of our tactical AI system is to coordinate the efforts of the group of units. The implementation of this type of AI is important when our group of units use a real-time game strategy and tactical methods. Our group of units are effective because the support each other and act as a single unit, all sharing information and the load of acquiring and distributing information.

The present AI system is built around group dynamics, which requires the game to keep track of different location of units, their orientation to each other and their orientation to the player. Our group of units are updated with a dedicated update module that keeps track of their goals, and their composition.

A single unit of the group is assigned the role of group captain. Every other member of the group keeps a link to this captain, and they get their behavioral cues from checking the orders of the group captain. The group captain handles all the tactical AI calculations for the whole group.

Governing these interactions is where the real work lies with our strategic AI. The captain explores the game maps to find the best challenge for the player-identify key points of interest such as potential points, players weaknesses, and player's sport.

Decision maps are possible patterns/configuration the player can engage and the many possible decisions they can make. Objective maps are filled with information about the goals of the player, player weaknesses, and passed performances. Resource maps contain information about possible obstructions the AI system can use, the history of performance of the player when facing that obstruction, and where/when each obstruction can best be deployed.

The following are the steps of one embodiment, from the beginning through the second pillar engagement.

Step 1: Set up pillars in two parallel lines of 4 (preprogrammed alpha configuration 1). There are 4 alpha configurations: 1—two parallel lines, 2—one line, 3—Circle 10 yard diameter, 4-Circle 10 feet diameter.

Step 2: (Optional) Players name, sport, age, height, weight, and region is entered in to the control unit. All data will be stored for upload and used by the adaptive learning software to produce customized challenges for each player.

Step 3: Set skill level to 3. There are 5 skill levels: 1—Beginner, 2, Limited, 3-Intermediate, 4—Advance, and 5—Expert.

Step 4: Set player's starting position (center) and timer to begin countdown to start in 5 seconds. There are multiple starting points possible: 1—center of configuration, 2—a position between two pillars indicated by user, 3—engagement with control unit. There are multiple ways to start the sequence: 1—setting timer to start between 5-15 seconds, 2—audible engagement, 3—the push of the start button.

Step 6: Computer highlights the first pillar, #D (A-H are the other possible targets), on its left side. The player must make contact or run alongside of the left side of the pillar.

Step 7: Player starting in center of pattern engages highlighted pillar #D.

Step 8: Computer evaluates players speed from start point (center) to engagement of highlighted pillar #D.

Step 9: Computer determines the speed of player to be 1.38 seconds.

Step 10: Computer labels the player as a moderate level performer.

Step 11: Computer determines the next pillar to be highlighted, based on speed and the side of the previous pillar engaged.

Step 12: Computer highlights the second pillar #B on its right side.

Step 13: Player engages the second pillar #B on its right side.

The following is a high-level description of the progress of the main algorithm (for version Simple Minimax) is as follows:

1. ComputerMove: Scans the playing field and makes all possible moves.

2. MoveFilter: A function to filter the moves scanned in order to increase speed.

3. ComputerMove: The program checks the player's speed and orientation, distance of units, units' orientation, and angle of approach of these possible moves.

4. ComputerMove2: Scans the playing field and makes all possible moves at the next thinking level.

5. ComputerMove: The program checks the player's speed and orientation, distance of units, units' orientation, and angle of approach of these possible moves.

6. ComputerMove3: Scans the playing field and makes all possible moves at the next thinking level.

7. ComputerMove: The program checks the player's speed and orientation, distance of units, units' orientation, and angle of approach of these possible moves.

8. ComputerMove4: Scans the playing field and makes all possible moves at the next thinking level.

9. ComputerMove: The program checks the player's speed and orientation, distance of units, units' orientation, and angle of approach of these possible moves.

10. ComputerMove5: Scans the playing field and makes all possible moves at the next thinking level.

11. (if thinking depth reached)=>record the score of the final position in the NodesAnalysis array.

The score before every human opponents move and after any human opponents move are stored in the Temp_Score_Human_before_{—}2 (i.e. the score after the first move of the H/Y and before the 1st move of human. while at the 2nd-ply of computer thinking), Temp_Score_Human_after_{—}2, etc. variables.

At every level of thinking, the scores are stored in the NodesAnalysis table. This table is used for the implementation of the MiniMax algorithm.

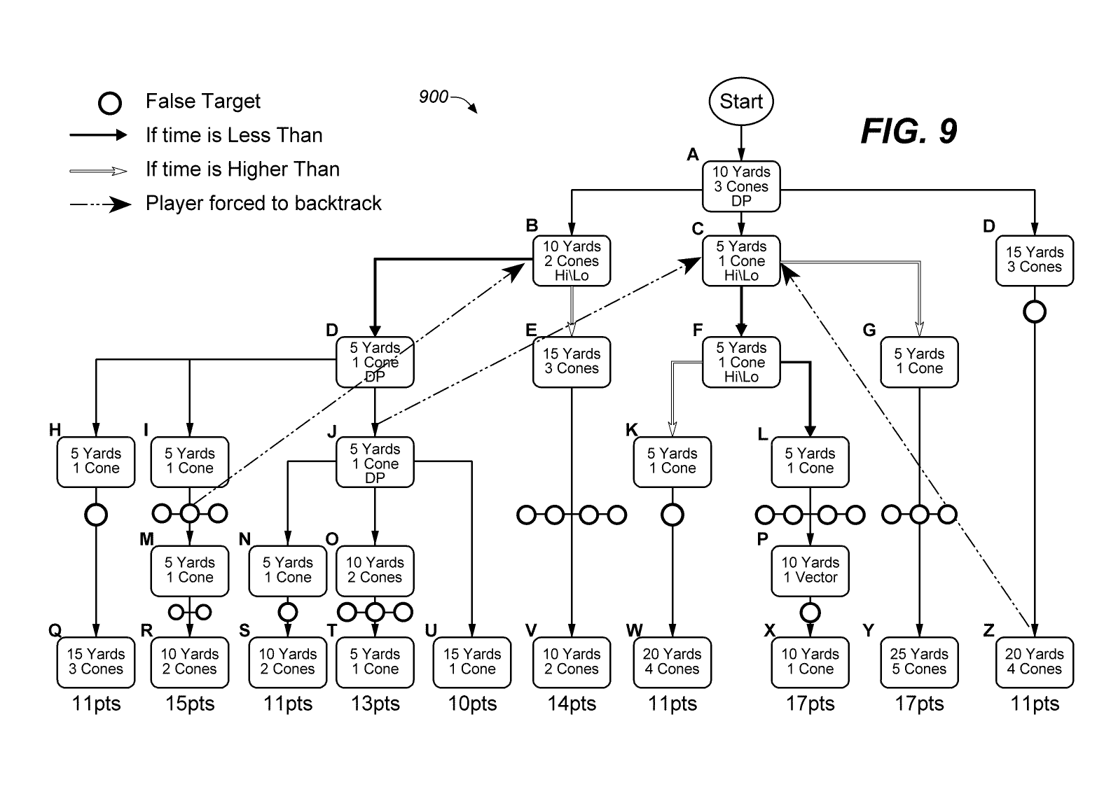

FIG. 9 illustrates a game tree 900 that may be used by an AI algorithm. In general. a game tree is generated from a simulation, and values are assigned to each branch based on the number of units engaged (false targets and true targets). Hundreds of game trees are possible, and each game tree may be used to generate a multitude of games.

In developing game tree 900, a simulation of is run where a computer making a move, A, which allows the game to move to states B, C or D. Unit A forces the player to choose which unit he will go to next. The player's choices are B, C or D. Each choice represents different branches within the game tree. The red circles represent false targets the player must contend with along the path. The player makes the final move and will reach 1 of 10 terminal states shown at the bottom represented by letters Q through Z.

The game tree assigns points to each terminal state. For instance, terminal state Z's highest possible score is 11 points. The points are based on the number of units engaged along that branch and rather or not the player engaged them properly. Points are subtracted if a player engages a unit improperly (by engaging a unit too late or by engaging a false target). Engaging a unit improperly can also result in the player being sent back up the game tree.

### Examples

In one embodiment, the system includes a Control Unit that communication with a plurality of Units. The Units are place in a field and, according to commands from the Control Units, are activated to provide visible and/or audible signals to a user. When the user interacts with an activated Unit, the interaction causes the Unit to send information to the Control Unit, and other Units may be activated.

The system may also include two or more Control Units comprising a Master Control Unit that communicates with one or more Secondary Control Units which, in turn communicate the Units. In one embodiment, for example, each Unit is within wireless communications range of one or more Control Units. The Units are activated (for example by illuminating a light or emitting a sound, or moving a flag attached to the Unit) by the Control Units in a sequence that may be fixed or which may be responsive to the user's contact with the Units. Each unit also includes means to be actuated—for example, by including a switch which the user must engage.

The Control Units accept commands from a programmer to set-up, change or add system settings for the Units by communicating with the Master Control Unit, which in turn selectively shares information with individual secondary Control Units by a process of synchronization (“synching”). Secondary Control Units share instruction and are given access to settings, data and programs through the process of synching.

During synching, the Master Control Unit transmits a signal to the other, secondary Control Unit(s), initializing the changed setting, requesting updates and the permission to upload instructions. According to this embodiment the synchronization serves as a temporary link for transmitting instructions. The synching initiating function will be stored in all Control Units thus simultaneously allowing commandeering Control Units to be commandeered. All Control Units will request an update when they link to one another.

There are many different configurations for the operation of the system. In one embodiment, the sequence of Units is fixed. In another embodiment, the system highlights units based on user times. In a third embodiment, the system provides options (more than one highlighted unit) and then highlights additional units based on which unit the user runs to.

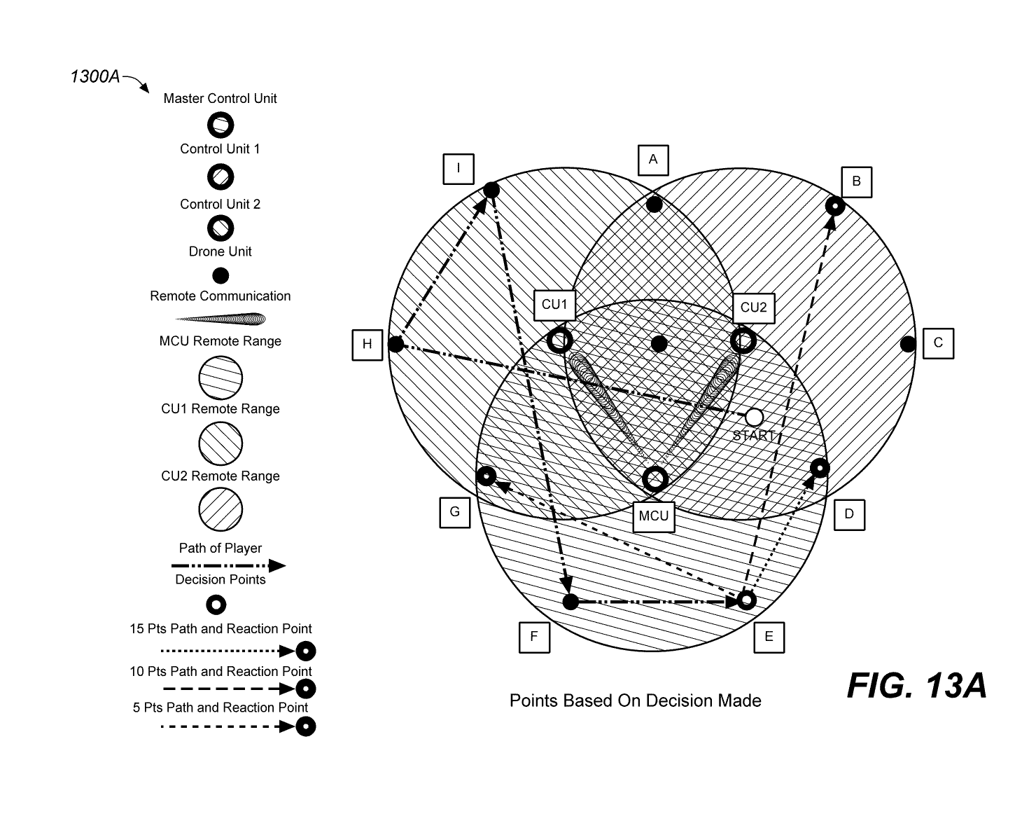

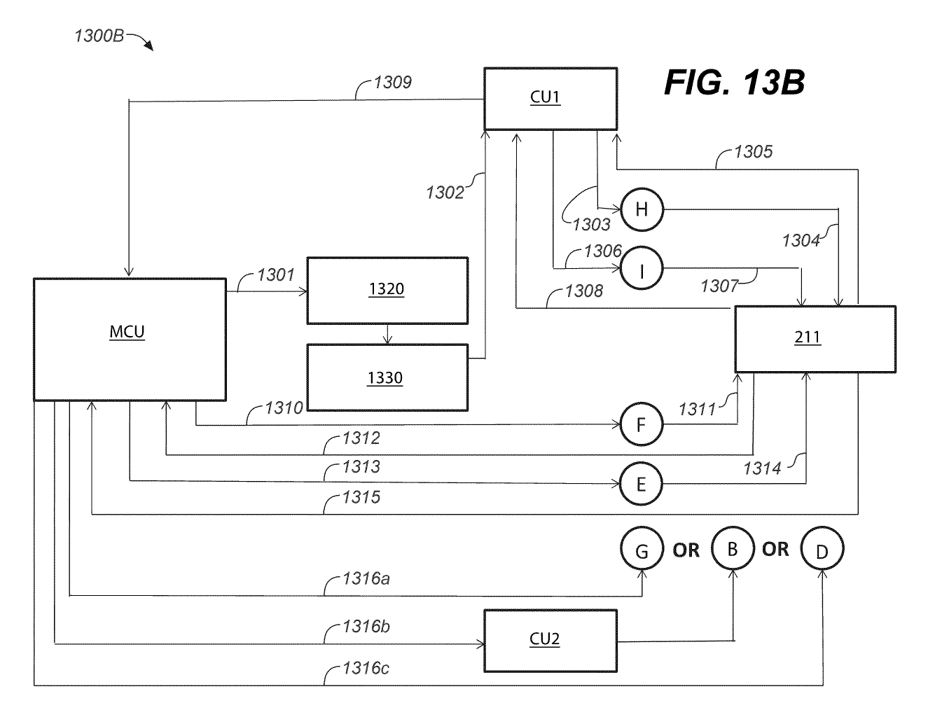

FIGS. 13A and 13B show a first example of a game, where points are calculated based on decisions made by the user, where FIG. 13A is a view of the units and FIG. 13B illustrates the game logic.

The system of FIG. 13A includes a Master Control Unit (MCU), two secondary control units: Control Unit 1 (CU1) and CU2 (CU2), and 10 drone units, also referred to as “Decision Points,” designated as A through J, and which may be generally similar to units 200. Also shown in FIG. 13A is an indication of the range of the MCU, CU1, and CU2, and which control units are in communication with which unit.

As one example of how system 100 may be programmed, this example illustrates a pattern comprising a sequence of Units H, I, F, E, followed by three options: G, B, or D. In this game, Decision Points can be engaged at any point during the course as many times as is provided by the pattern, The objective of using Decision Points is to force the player to make a decision based on their competitive and physical endurance. The player will continue to transverse the course engaging as many reaction points as provided.

First, the master control unit MCU initiates a countdown 1320 to start the pattern, and obtains pattern information 1330 from the memory of hand-held device 110. From pattern information 1330, system 100 determines which control unit must send signals to which units, and when. Once countdown 1320 reaches zero, in the example of FIG. 13A, the signaling of the first unit, Unit H, is initiated, and CU1 sends out a signal 1303 to Unit H causing it to signal the player, such as by lighting lights 213 on Unit H. The player proceeds to engage Unit H, indicated as interaction 1304, such as by activating touch sensor 211 on Unit H. After Unit H is engaged, the unit sends a signal and information 1305 to the CU1. The next reaction point to be highlighted, reaction point I, is also located within the range of CU1. CU1 sends a signal 1306 to Unit I, which then signals the player, as by lighting lights 213 on Unit I. The player then moves towards and eventually engages Unit I, indicated as interaction 1307, such as by activating touch sensor 211 on Unit I After Unit I is engaged, the unit sends a signal and information 1308 to CU1.

The next reaction point to be highlighted, reaction point F, is located within the remote range of the designated MCU. In order for reaction point F to be highlighted, CU1 sends out a signal 1310 to Unit F causing it to signal the player, such as by lighting lights 213 on Unit F. Once the player engages reaction point F, indicated as engagement 1311 of sensor 211 of Unit F, the MCU is notified by signal 1313, and the Decision Point function is engaged. Reaction point E is designated as a Decision Point. A signal 1313 is sent to Unit E, which signals the player and notes the interaction 1314 with sensor 211 of unit E, which then notifies, via signal 1315, the MCU. The player is next given three options of highlighted reaction points—G, B and D. Specifically, MCU sends signals 1316a, 1316b, and 1316c to units G, B, and D, through the corresponding control unit, respectively. Thus, signal 1316b is sent to unit B through CU1. Once sensor 211 is engaged in one of units G, B, or D, a signal (not shown) is sent back, through a control unit if required, to the MCU.

At this point, MCU, hand-held unit 110, or server 120 may calculate a score for the player. Each reaction point within the decision mode is given a point value based on the difficulty it would take for the player to engage it. Reaction point G is the most difficult reaction point to engage and is worth 15 point. Reaction point B is the second most difficult reaction point to engage, its point value is 10 points. Reaction point D is the least difficult reaction point to engage, its point value is 5 points.

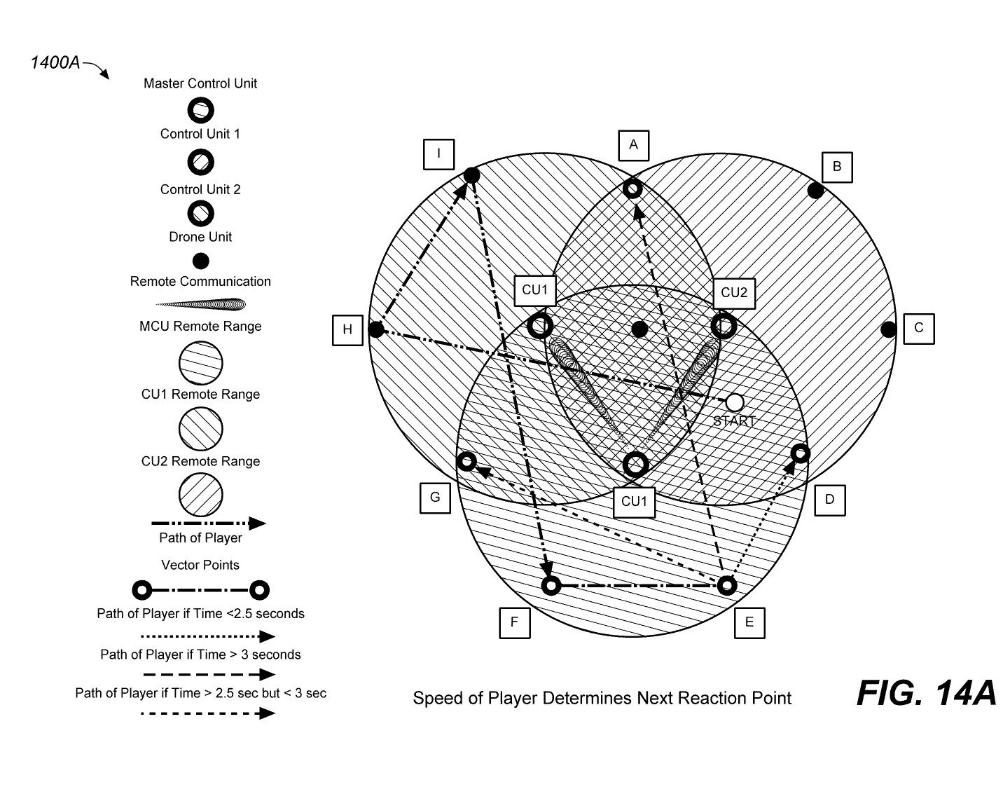

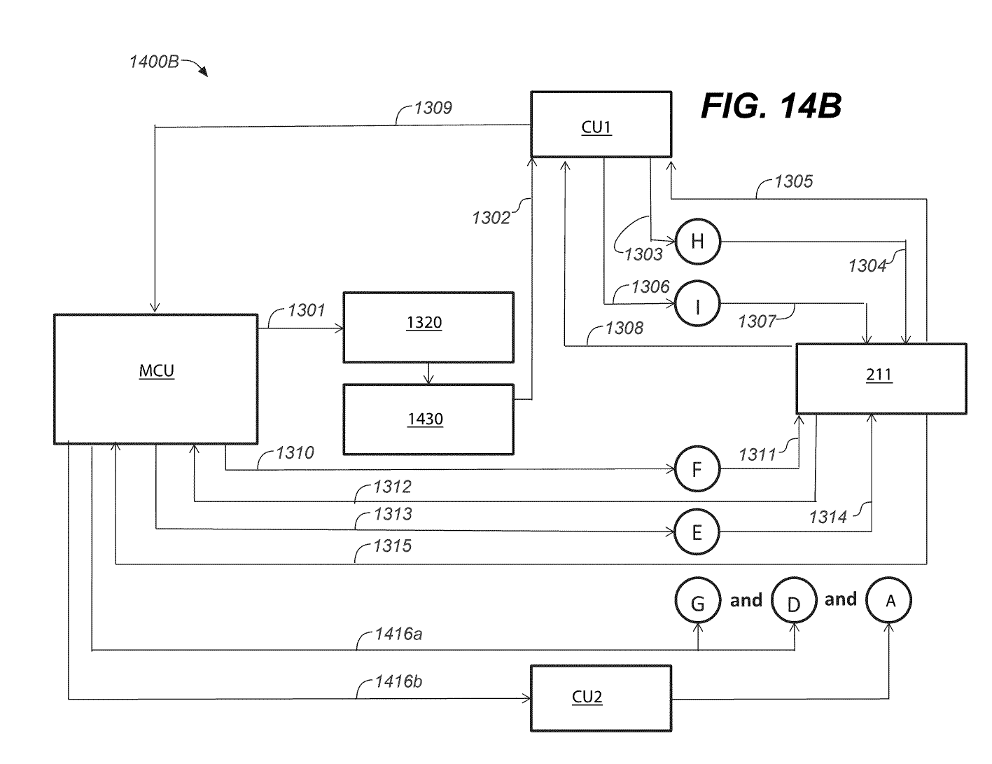

FIGS. 14A and 14B show a second example of a game, where the speed of the user determines the next reaction point, where FIG. 14A is a view of the units and FIG. 14B illustrates the game logic. The game of FIGS. 14A and 14B are generally similar to that of FIGS. 13A and 13B, except where explicitly stated.

In initiating the game, the MCU obtains pattern data 1420 which is used for providing the timing and sequence of the game. The player proceeds to engage reaction points H, I, and F, as described with reference to FIGS. 13A and 13B. In this game however, once the player engages reaction point E the Decision Point function is engaged. Reaction point E is designated as a Vector Point. A Vector Point determines the course ran based on the speed of the player between two points. The vector points can be engaged at any point during the course as many times as provided by the pattern. The objective is to force the player to run the most difficult route based on their ability. The player will continue to transverse the course engaging as many reaction points as provided.

The player proceeds to engage reaction point F. After reaction point F is engaged via Unit F's sensor 211, Unit F sends a signal and information back 1312 to the MCU. The MCU sends out a signal 1313 that causing Unit E to signal the user. Reaction point E is designated as the second of two vector points. After reaction point E is engaged it sends a signal and information 1315 to the MCU, and the MCU calculates the time between the two vector points. Three possible outcomes are possible based on the time between the two vector points. If the player's time is equal to or less than 2.5 seconds the MCU, for example, the MCU sends a signal and information 1416a to reaction point G to signal the player. If the player's time is equal to or greater than 2.51 seconds but less than or equal to 3 seconds, then signal 1416a is sent to Unit D to signal the player. If the player's time is greater than 3 seconds the MCU will send a signal and information 1416b to CU2. CU2 will send out a signal and information highlighting causing Unit A to signal the user, via lights on that unit.

Once sensor 211 is engaged in one of units G, B, or D, a signal (not shown) is sent back, through a control unit if required, to the MCU, and the player's results may be recorded.

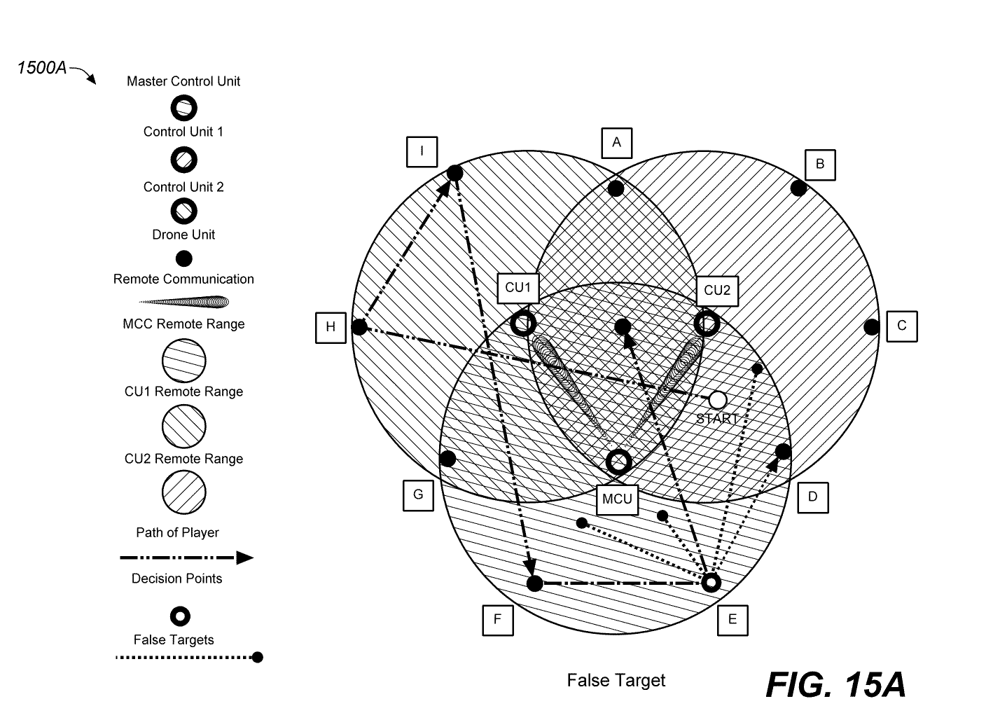

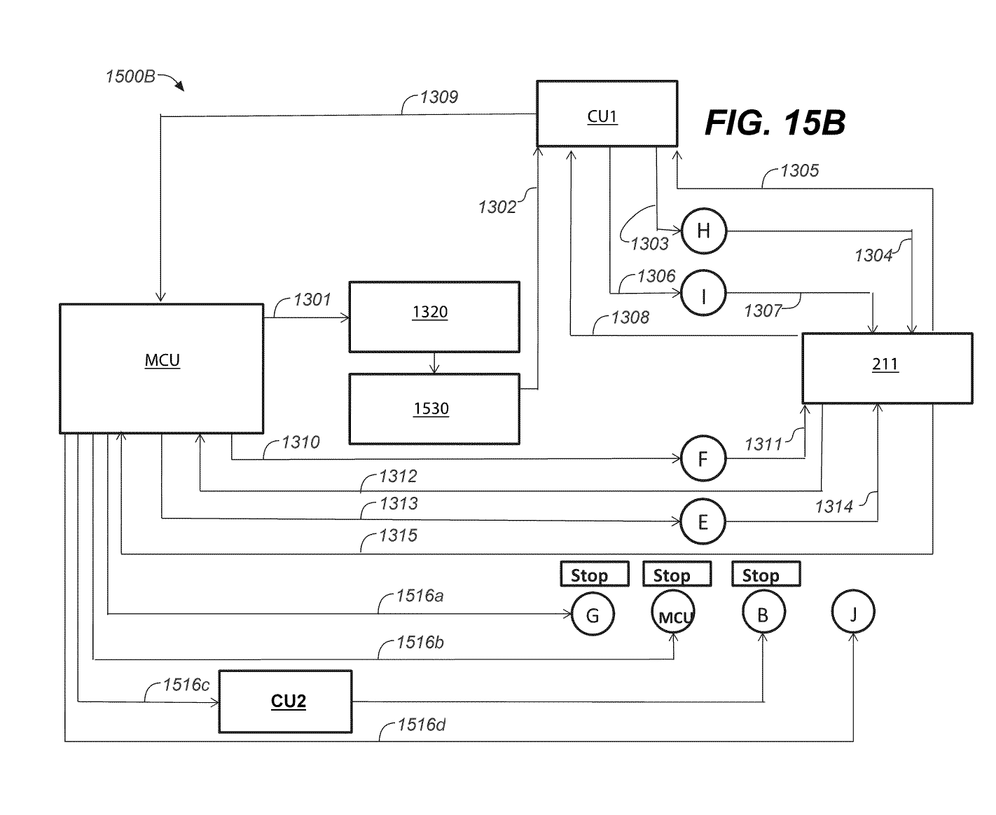

FIGS. 15A and 15B show a third example of a game, where the user is presented with a false target, where FIG. 15A is a view of the units and FIG. 15B illustrates the game logic.

In initiating the game, the MCU obtains pattern data 1520 which is used for providing the timing and sequence of the game. The player proceeds to engage reaction points H, I, and F, as described with reference to FIGS. 13A, 13B, 14A, and 14B.

Once the player engages reaction point E, however, the False Target function is engaged, wherein several units sequentially send visual signals to the user to advance towards the units, without actually engaging the units. Thus, one unit will provide a white light for some period of time, after which the light turns red, and another unit signals a white light.

Reaction Point E is designated as a False Target Station. When the player engages Reaction Point E the MCU sends out a signal 1516a to Reaction Point (Unit) G. According to the pattern information, after some amount of time, Unit G signals with a red light, indicating that the player should direct their attention to some other unit. When Reaction Point G turns red MCU signals, via a signal 1516b, to itself to provide a visual signal to the player. The MCU turns red as the player makes his way toward it, ending the player's attempt to engage it. When The MCU turns red it then sends a signal 1516c to CU2, which in turns sends out a signal to Unit B to send a white signal. After some predetermined time, Reaction Point B turns red as the player makes his way toward it, ending the player's attempt to engage it. When Reaction Point B turns red a signal 1516d is sent to Unit J. Reaction Point J is the true reaction point. If any of the false targets are engaged by the player points will be deducted. The player will continue to transverse the course engaging as many reaction points as programmed.

One embodiment of each of the methods described herein is in the form of a computer program that executes on a processing system, e.g., a one or more processors that are part of a system. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the Block diagrams and operations may be interchanged among functional Blocks. Steps may be added or deleted to methods described within the scope of the present invention.

We claim:

1. A system for executing a training run of a user in a field, said system comprising:
two or more units arranged in a layout on the field, where at least two of said two or more units includes a device for signaling the user and a device for determining the proximity of the user to the unit, and
a programmable computing device programmed with a pattern for executing the training run, where said pattern includes a sequence of when one or more of said two or more of said plurality of units provides a signal to the user,
where said programmable computing device is further programmed to modify the pattern during the training run.

2. The system of claim 1, where said device for signaling the user includes a light.

3. The system of claim 1, where said device for determining the proximity of the user includes a touch sensor.

4. The system of claim 1, where said system includes a hand-held device programmed to operate the system, where one of said two or more units is a master control unit, where the hand-held device wirelessly communicates with said master control unit, and where said master control unit wirelessly communicates with each of the other two or more units.

5. The system of claim 1, where said programmable computing device is programmed to modify the pattern according to the time a user runs between two of said two or more units.

6. The system of claim 1, where said sequence includes at least two units of said two or more units simultaneously signaling the user.

7. The system of claim 1, where the programmable computing device is further programmed to generate a score corresponding to the user's time and/or speed for executing the training run.

8. The system of claim 7, where said programmable computing device is programmed to modify the pattern according to which of said at last two units are engaged by the user.

9. A method for executing a training run of a user in a field utilizing a programmable computing device programmed for:
sending a sequence of instructions to one or more units of a plurality of units on the field, where each instruction causes the unit to generate a signal for the user;
determining the time between the generating of the signal for the user and the time required for the user to reach the proximity of the unit generating the signal; and
modify the sequence of instructions during the training run.

10. The method of claim 9, where said modifying modifies according to the time that the user runs between two of said two or more units.

11. The method of claim 9, where said modifying modifies according to which unit of said at last two units are engaged by the user.

12. The method of claim 9, further comprising generating a score corresponding to the user's time and/or speed for executing the training run.

13. A system for providing a layout of units for training a user in a field, said system comprising:
two or more units for placing on the field, where said system includes means for trilateralization of the position of units on the field; and
a programmable computing device including a memory storing a predetermined layout of said two or more units,
where said programmable computing device is programmed to prompt the user to place said two or more units at locations corresponding to the predetermined layout.

14. The system of claim 13, where said means for trilateralization of the position of units on the field includes one or more speakers and one or more microphones on each of said two or more units.

15. The system of claim 13, where said programmable computing device includes a display, and where said a programmable computing device is programmed to provide a map of the predetermined layout and the position of the units on the field as determined by said means for trilateralization.

16. The system of claim 13, where said programmable computing device is programmed to present two or more options for the placement of units on the field to resolve ambiguities in the trilateralization of the units.

17. A method for placing units on the field for training a user using a programmable computing device, said method comprising:
providing a map on a display of the programmable computing device, where said map includes a predetermined layout of two or more units on the field;
prompting the user, with the programmable computing device, to place units on the field according to the provided map;
determining the actual placement of units on the field by trilateralization; and
prompting the user to move units on the field according to the predetermined layout.

18. The method of claim 17, further comprising the programmable computing device presenting the users with two or more options for the placement of units on the field to resolve ambiguities in the trilateralization of the units.

19. The method of claim 17, further comprising providing said user with a selection of two or more predetermined layouts.

20. The method of claim 17, where said programmable computing device is further programmed to allow the user to select a pattern for training a user corresponding to the predetermined layout.
